(19) United States
(12) Patent Application Publication
(10) Pub. No.: US 2024/0086235 A1
(43) Pub. Date: Mar. 14, 2024

(54) Estimating Resource Costs for Computing Tasks for a Reconfigurable Dataflow Computing System

(71) Applicant: SambaNova Systems, Inc., Palo Alto, CA (US)

(72) Inventors: Tianxiao JIANG, Katy, TX (US); Jian ZHANG, San Jose, CA (US); Etash Kumar GUHA, Florence, SC (US); Andrew DENG, San Jose, CA (US); Muthiah ANNAMALAI, Hayward, CA (US)

(73) Assignee: SambaNova Systems, Inc., Palo Alto, CA (US)

(21) Appl. No.: 18/367,764

(22) Filed: Sep. 13, 2023

Related U.S. Application Data
(60) Provisional application No. 63/417,456, filed on Oct. 19, 2022.
(60) Provisional application No. 63/406,196, filed on Sep. 13, 2022.

(51) Int. Cl. G06F 9/48; G06F 9/30

(52) U.S. Cl. CPC G06F 9/4881; G06F 9/3005

(57) ABSTRACT

Reconfigurable dataflow architecture is an emerging design for deep learning training accelerator. This architecture maps model operators to an accelerator in a spatial way, enabling pipeline parallelization for high throughput. An essential ingredient to exploit this throughput advantage is compiler Performance Optimization (PO) which searches for optimal model mappings. The convention in industry-leading dataflow compilation uses hand-tuned rules to guide PO, requiring immense engineering cost to develop. This paper challenges this convention and asks if data-driven learned performance optimization can reduce the engineering cost while improving training throughput over hand-tuned rules. We present a workflow which guides PO using simple machine learning models trained from throughput observations of randomly generated mappings. We empirically show that developing and integrating these learned models into an industrial compiler can be 10× more efficient than hand-tuned rules in terms of engineering time cost.

### CROSS-REFERENCES AND INCORPORATIONS

The following are incorporated by reference for all purposes:

This application claims the benefit of U.S. Provisional Patent Application No. 63/406,196 entitled “Learned Cost Models For Performance Optimization On Dataflow Architecture,” filed Sep. 13, 2022; U.S. Provisional Patent Application No. 63/417,456 entitled “Performance Optimization of Dataflow Processors,” filed Oct. 19, 2022; all of which are hereby incorporated by reference;
Prabhakar et al., “Plasticine: A Reconfigurable Architecture for Parallel Patterns,” ISCA '17, Jun. 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

### BACKGROUND

### Technical Field

The technology disclosed relates to executing an interpreted language using hardware that includes a coarse-grained reconfigurable (CGR) processor. In particular, it relates to flattening a computing graph and identifying repeated patterns of code.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

A machine learning model can be represented as a computing graph. An interpreter executing the computing graph may divide the computing graph into sections and map each section to hardware prior to executing each section. However, as the graph grows larger and larger, the number of sections to map increases, slowing down the interpreter and therefore slowing the execution of the computing graph.

### SUMMARY

The technology disclosed relates to interpreted languages.

A software program implementing one or more artificial intelligence algorithms is compiled to create intermediate code. An interpreter retrieves a line of code included in the intermediate code. If the interpreter determines that the line of code includes a hypersection definition, the interpreter creates a hypersection based on the hypersection definition and associates a name with the hypersection based on the hypersection definition. The interpreter retrieves one or more subsequent lines of code that are associated with the hypersection and adds the one or more subsequent lines of code to the hypersection. The interpreter configures and executes the hypersection. If the interpreter retrieves an additional line of code in the intermediate code that references the hypersection, then the interpreter determines the code included in the hypersection, reconfigures the hypersection to create a reconfigured hypersection, and executes the reconfigured hypersection.

Particular aspects of the technology disclosed are described in the claims, specification and drawings.

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused-control memory unit (FCMU).

FIG. 6 is a block diagram of a compiler stack implementation suitable for generating a configuration file for a CGR processor.

FIG. 7 shows an example user program in an example first stage of the compiler stack.

FIG. 8 shows the user program in an example second stage of the compiler stack.

FIG. 9 shows the user program in an example third stage of the compiler stack.

FIG. 10 shows the user program in an example fourth stage of the compiler stack.

FIG. 11 shows the logical computation graph and an example physical layout of the user program.

FIG. 12 shows an example of pseudocode to define a hypersection.

FIG. 13 shows a logical computation graph that includes 2 sections that will be used to create 2 hypersections.

FIG. 14 illustrates executing a logical computation graph in which a hypersection is executed twice.

FIG. 15 illustrates executing a logical computation graph in which a hypersection is executed four times.

FIG. 16 illustrates a flowchart of a process that includes creating and executing a hypersection.

FIG. 17 illustrates a flowchart of a process that includes executing a previously defined hypersection.

FIGS. 18a and 18b show: (a) Reconfigurable Dataflow Units (RDU): Hardware using dataflow architectures consisting of a large array of functional units (Compute/Memory/Switch) which enable computation and communications to happen on-chip. (b) Mapping computational graph onto RDU: To train a DNN on RDU, a compiler takes in an arbitrary computational graph, determines the parallelization for each operator in the Resource Allocation (RA) stage and then spatially places them to the array of units and route the data with on-chip interconnect in Placement and Routing stage (PNR).

FIG. 19 shows: In a pipeline fashion, samples flow through the operators of the computational graph mapped to the computational chip.

FIG. 20 shows: Parallelization allocation (PA) and placement and routing (PnR) both have exponentially large search space. Exhaustive trial is infeasible for user expectations on compile time. |U|, |W|, |V|, |E| are the set cardinally of on-chip units, communication fabrics, the compute graph operator and the inter-operator connections.

FIGS. 21a and 21b: (a) The MLP takes information about a parallelization, P, and information about the operator to be parallelized, I, and uses connections between the inputs and the hidden layers to create predictions for the Compute Unit usage (C), the Compute Unit usage (M), and the Latency (L) of the parallelization. (b) An example of placement graph on dataflow hardware that consists an array of functional units including compute units, memory units and switches. Different units are used for different operators and marked by different colors. Each color signifies the operator to which the node is assigned from 18b. (c) The placement graph can be modeled by the Graph Neural Network (GNN). Message passing and aggregation (AGG) learns graph level representations for each node which can be used to predict the cost of placement graph: the throughput of the model when deployed on chip.

FIG. 22 illustrates the disclosed design of the PA cost model.

FIG. 23 shows a regression loss minimized by the technology disclosed.

FIGS. 24a, 24b, and 24c show a coupling of the disclosed learned cost model with a simple nested binary search algorithm to solve the constrained parallelization allocation problem.

FIG. 25 shows use of a standard neighborhood aggregation methods to integrate information from the node and edge, which generates node-level representations zu∈Rdu.

FIG. 26 illustrates Table 1: Engineering Time Required to Design Cost Model for PA and PnR in Months.

FIG. 27 shows Percent Throughput Improvement on Submodules and Full Modules.

FIG. 28 illustrates Table 2: Prediction Error (Average Absolute Percentage Error) for GEMM operations.

FIG. 29 depicts that the disclosed data-driven cost model for PnR is more accurate at predicting the throughput of spatial configurations for submodules such as FFN and MHA.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as coarse-grained reconfigurable (CGR) architectures (CGRAs) or graphic processing units (GPUs). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

For languages such as Python, a compiler converts (e.g., compiles) the source code into an intermediate language, called byte code, and then an interpreter executes the byte code in real time. The interpreter basically converts (e.g., interprets), in real time, the byte code into machine code that is executable by the underlying hardware processor(s). Artificial intelligence (AI) models typically create a large amount of Processor Executable Format (PEF) (e.g., byte code), resulting in the compiler and the interpreter taking a large amount of time to process the code. To address this issue, the systems and techniques described herein represent a repetitive pattern in the computing graph as a hypersection. Each hypersection may be unique and a computing graph may include multiple hypersections. Mapping and place and route (PnR) is performed for unique hypersections, resulting in ten times faster execution or greater.

A hypersection is a mechanism to group operations into separate mapping entities. For example, a computing graph may be traced as a DAG (Directed Acyclic Graph) that includes tensors and operations. A set of operations may be grouped into a hypersection. In this way, hypersections implementing the same functionality may share the same mapping/PnR. For example, a hypersection annotation to nn.module may be made via decorator (or similar). Samba tracing may annotate each trace operation with hypersection information. Hypersections may be enabled by the software developer enabling a compiler option, e.g., “--enable-hypersection”. The compiler may use multiple passes. In a first pass, the compiler may convert a flattened computing graph into a HyperGraph, based on HyperSection annotations in the code. In a second pass, a Model Analyzer Compiler (MAC) performs autograd to determine gradients for parameters. In a third pass, the MAC may perform a mapping per function. In a fourth pass, the MAC may create function definitions and schedule function calls.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetical, or mechanical, between the things that are connected, without any intervening things or devices.

The term configured (to perform a task or tasks) is a broad recitation of structure generally meaning “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

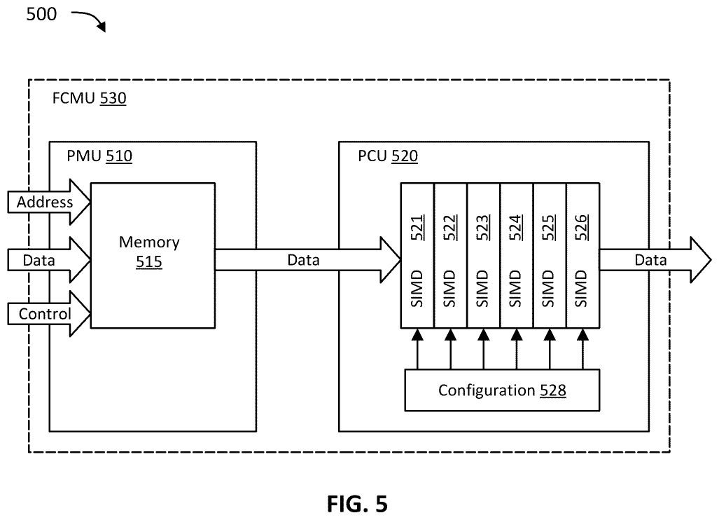

Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CU—coalescing unit.

Dataflow Graph—a computation graph that includes one or more loops that may be nested, and wherein nodes can send messages to nodes in earlier layers to control the dataflow between the layers.

Datapath—a collection of functional units that perform data processing operations. The functional units may include memory, multiplexers, ALUs, SIMDs, multipliers, registers, buses, etc.

FCMU—fused compute and memory unit—a circuit that includes both a memory unit and a compute unit.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

A logical CGR array or logical CGR unit—a CGR array or a CGR unit that is physically realizable, but that may not have been assigned to a physical CGR array or to a physical CGR unit on an IC.

Metapipeline—a subgraph of a computation graph that includes a producer operator providing its output as an input to a consumer operator to form a pipeline. A metapipelines may be nested within another metapipeline, that is, producer operators and consumer operators may include other metapipelines.

ML—machine learning.

PCU—pattern compute unit—a compute unit that can be configured to repetitively perform a sequence of operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.

Pipeline Stages—a pipeline is divided into stages that are coupled with one another to form a pipe topology.

PMU—pattern memory unit—a memory unit that can locally store data according to a programmed pattern.

PNR—place and route—the assignment of logical CGR units and associated processing/operations to physical CGR units in an array, and the configuration of communication paths between the physical CGR units.

RAIL—reconfigurable dataflow unit (RDU) abstract intermediate language.

CGR Array—an array of CGR units, coupled with each other through an array-level network (ALN), and coupled with external elements via a top-level network (TLN). A CGR array can physically implement the nodes and edges of a dataflow graph.

SIMD—single-instruction multiple-data—an arithmetic logic unit (ALU) that simultaneously performs a single programmable operation on multiple data elements delivering multiple output results.

TLIR—template library intermediate representation.

TLN—top-level network.

### Introduction

The use of machine learning for compiler optimization is a rapidly growing field of research. However, due to the unique architecture and associated compiler design challenges of reconfigurable dataflow hardware, this is to our knowledge the first study of data-driven cost models guiding compilations for a reconfigurable dataflow architecture. Research on using machine learning for compiler optimization has seen interest in code footprint reduction, power reduction and accelerating execution speed (Wang et al., 2019). Earlier work such as TVM proposed to use machine learning cost models on compiler for deep learning (Chen et al., 2018), targeting end-to-end compiler optimization for CPUs and GPUs. This is, however, a different problem from compiler optimization in dataflow architectures due to fundamental differences at the hardware level. Similarly, leveraging ML techniques in the cost model design for hardware level placement and routing is an active research area for VLSI chip design (Mirhoseini et al., 2021; Liu et al., 2020; Li et al., 2020), which is concerned with optimizing the outcomes of the relatively slow process of VLSI hardware placement. This approach is difficult to generalize to compiler optimization due to compilers being run far more frequently than VLSI chip design place and route procedures.

The strategy of using graphs to visualize the compiler process to conduct Compiler Optimization more effectively is a time-tested strategy in VLSI. Here, the authors proposed a similar idea of using embeddings to encode the circuit graph at the transistor level, to predict performance for chip placement. However, there are still three major differences compared to our work. Their graphs were much smaller than ours, the performance labels are obtained through simulations rather than real measurements as in our work and only the placement is modeled in their work, while we additionally model the routing. In Mirhoseini et al. (2021), the idea of using a GNN to predict the return in the value network of a RL placer is similar to a cost model. However, instead of training on real measurements, they use a performance estimation proxy for the final reward to reduce the overhead in environment interaction. In addition to graphs, several other non-rule-based cost models have been analyzed for compiler optimization. A recent study focusing on CPUs uses actual measurements like ours to learn cost model for scheduling. However, only MLPs are used there due to the reduced complexity of the problem compared to the dataflow architecture case (Hunter et al., 2022). Another popular PnR algorithm is to formulate the hardware constraints into an Integer Linear Program (ILP) (Nowatzki et al., 2013). However, the cost model has to be simple and linear to be used in ILP, making extension to PnR on dataflow architecture difficult due to more complex hardware constraints.

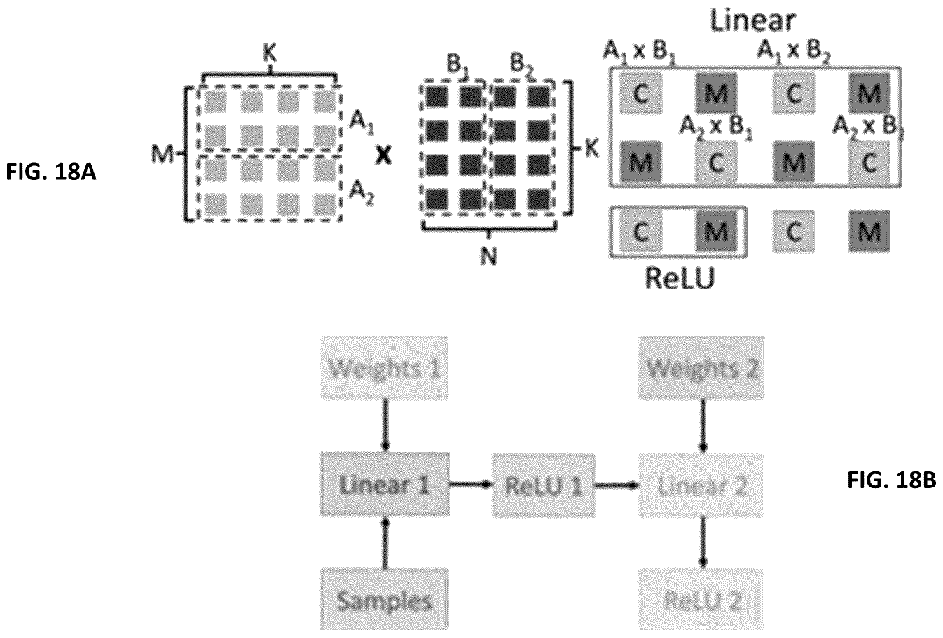

The dataflow architecture is a hardware micro-architecture widely adopted in emerging deep learning training accelerators (Prabhakar et al., 2017; Chen et al., 2017) consisting of a large on-chip array of compute and memory units as shown in FIG. 18a. In contrast to a GPU's serial execution of operators using off-chip memory (Luley, 2020; Leng et al., 2013; Ivanov et al., 2020), the faster on-chip memory units can accommodate more operators spatially and enable pipelined execution over operators across training samples. This execution mode creates opportunities for higher model training throughput. To materialize this advantage, a key compiler procedure is dataflow Performance Optimization (PO) which decides on the exact mapping from operators to the array of units to optimize training throughput. Dataflow performance optimization is challenging due to the large search space for operator mapping. When compiling operators spatially to the unit array, the number of possible mappings rises exponentially with respect to the number of operators and array units (Bloch et al., 2021; Michalska et al., 2017). In such large search spaces, two randomly sampled mappings for the same compute graph can differ in training throughput by a factor of 100×. Exhaustive search for PO is thus impractical when accounting for users' expectations with respect to compilation time (Chi et al., 2018; Wang and Liang, 2017). In industrial practice, PO is implemented as search procedures guided by a complex set of heuristic rules (Chi et al., 2018; Wang and Liang, 2017). The successful production deployment of these rule-based approaches typically faces two major engineering challenges when aiming to fully utilize the potential of dataflow hardware architectures. Firstly, these heuristic rule systems are tied to and depend on the detailed implementations of the software and hardware stacks. It thus takes tremendous human engineering time to design, maintain and upgrade the rule systems for fast-evolving emerging accelerators. Secondly, heuristic rules are typically developed based on the limited set of observed compute graphs and do not generalize perfectly to the vast number of possible model variations (Goens et al., 2017). This could lead to a training throughput gap compared to the manual mapping from human experts (Bloch et al., 2021). Motivated by these two challenges, we ask: can data-driven PO algorithms attain competitive or better training throughput over rule-based approaches with significantly less engineering costs?

To exploit the potential of data-driven PO, we propose a simple two-stage workflow which guides the mapping with machine learning models purely learned from empirical throughput observations. In the first stage, we trade-off precise compute graph context modeling for a simple and efficient per-operator approach to determine the number of memory and compute units for each operator. Specifically, we learn a single multi-layer perception model (MLP) to predict the fitness of resource allocations (RAs) for all types of individual operators. As the decisions on operators are decoupled, we exhaustively evaluate the projected fitness of all allocation possibilities of each operator. In spite of its simplicity, this approach surprisingly leads to strong training throughput in practice. Given the above resource allocation, our workflow then place operators and route (PnR) their connections to the physical locations of units and inter-unit communication fabrics. In this second stage, we evaluate the fitness of physical location plans with a graph neural network which encodes units as nodes and interconnect fabrics as edges. We use this model to guide simulated annealing search which naturally incorporate the context at the level of full compute graphs. We train our PA and PnR models on randomly sampled mappings and their empirical throughput for model building blocks such as residual convolutions and multi-headed attentions. The throughput collection and the model training trigger minimal manual engineering costs. As it is inexpensive to randomly sample many mappings to train the PA and PnR models, our workflow presents the promise to generalize well in terms of model variations. We prototype our data-driven workflow for modern deep learning models on an industry leading dataflow accelerator. Empirically, we first show that our data-driven PO workflow can significantly reduce the engineering time cost compared to existing in-production rule-based workflow. We then demonstrate that our workflow can achieve higher training throughput on unseen model configurations than the rule-based approach. Specifically, we demonstrate that it only takes 3 weeks to collect the mapping decisions and throughput to train the cost models in our workflow. In addition, each model training trial only takes up to 2.5 hours. This implies a more than 10× engineering cost reduction compared to in-production rule-based PO, according to the estimate from dataflow compiler experts. Our data-driven PO workflow can achieve many magnitudes of improvements in the training throughput of ResNet (He et al., 2015), Unet (Ronneberger et al., 2015), GPT-2 (Radford et al., 2019) and VIT (Dosovitskiy et al., 2020) as compared to the in-production rule-based method. We note that the exact configurations in these full models, such as sequence length, are not seen in the building blocks for training. The throughput improvement demonstrates the generalizability of our workflow with respect to model variations. The structure of the paper is as follows. In the Preliminary section, we discuss the dataflow hardware and its compiler, focusing on the traditional compiler's rules and their weaknesses. In the Learned Performance Optimization section, we introduce our data-driven method. This is followed by a section on our experiment results. Finally, we provide a conclusion section.

FIGS. 18a and 18b show: (a) Reconfigurable Dataflow Units (RDU): Hardware using dataflow architectures consisting of a large array of functional units (Compute/Memory/Switch) which enable computation and communications to happen on-chip. (b) Mapping computational graph onto RDU: To train a DNN on RDU, a compiler takes in an arbitrary computational graph, determines the parallelization for each operator in the Resource Allocation (RA) stage and then spatially places them to the array of units and route the data with on-chip interconnect in Placement and Routing stage (PNR).

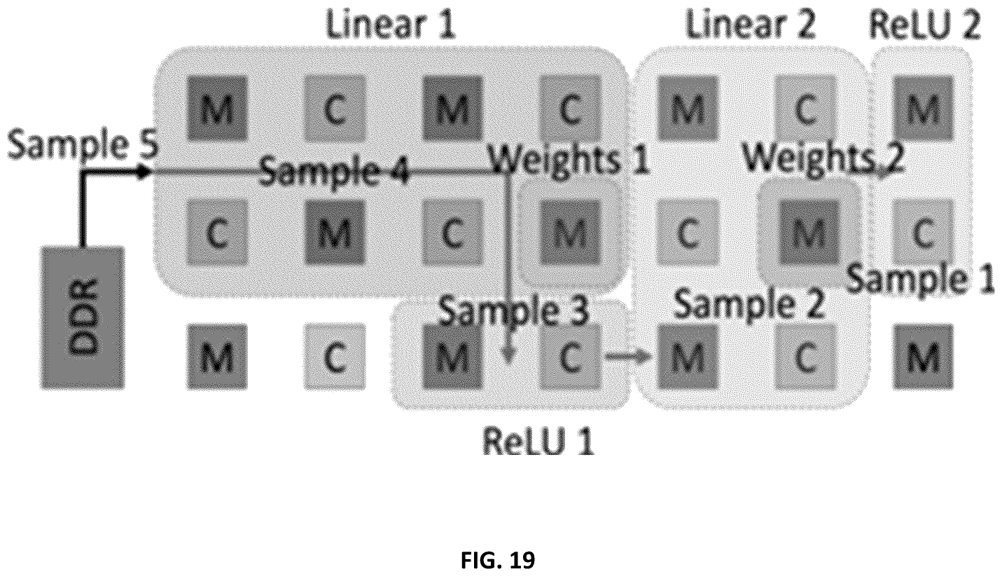

FIG. 19 shows: In a pipeline fashion, samples flow through the operators of the computational graph mapped to the computational chip.

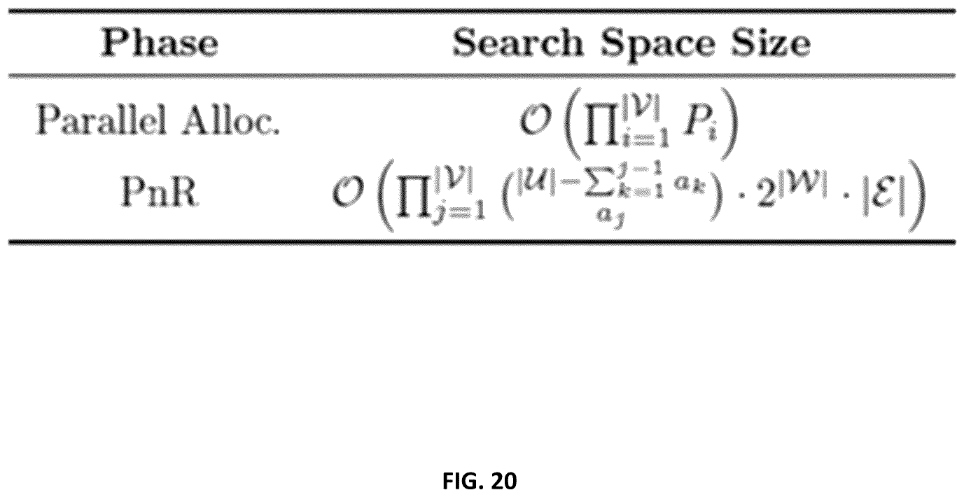

FIG. 20 shows: Parallelization allocation (PA) and placement and routing (PnR) both have exponentially large search space. Exhaustive trial is infeasible for user expectations on compile time. |U|, |W|, |V|, |E| are the set cardinally of on-chip units, communication fabrics, the compute graph operator and the inter-operator connections.

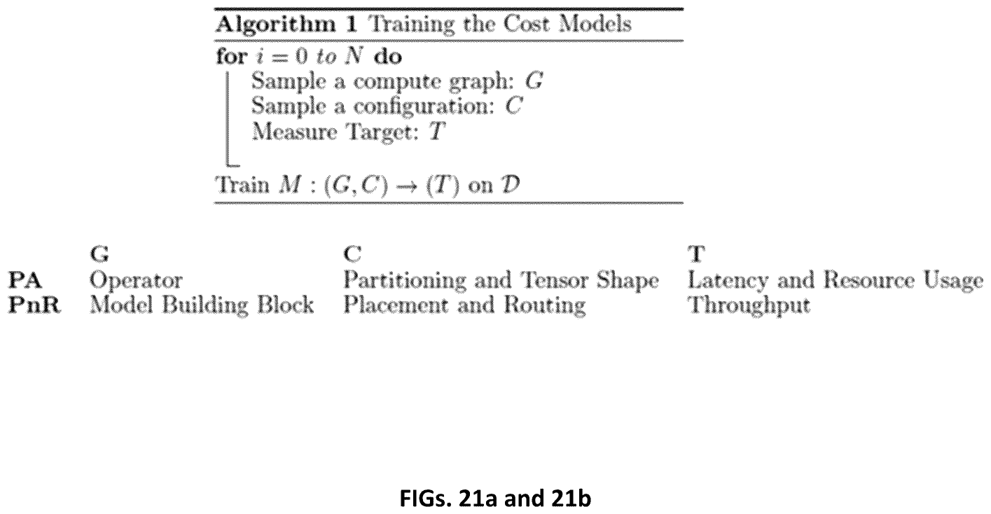

FIGS. 21a and 21b: (a) The MLP takes information about a parallelization, P, and information about the operator to be parallelized, I, and uses connections between the inputs and the hidden layers to create predictions for the Compute Unit usage (C), the Compute Unit usage (M), and the Latency (L) of the parallelization. (b) An example of placement graph on dataflow hardware that consists an array of functional units including compute units, memory units and switches. Different units are used for different operators and marked by different colors. Each color signifies the operator to which the node is assigned from 18b. (c) The placement graph can be modeled by the Graph Neural Network (GNN). Message passing and aggregation (AGG) learns graph level representations for each node which can be used to predict the cost of placement graph: the throughput of the model when deployed on chip.

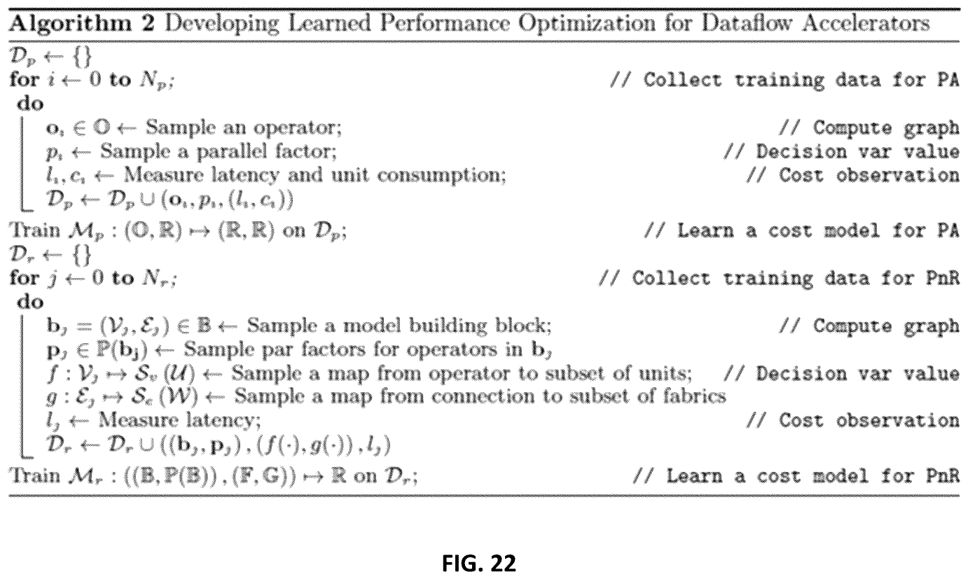

FIG. 22 illustrates the disclosed design of the PA cost model.

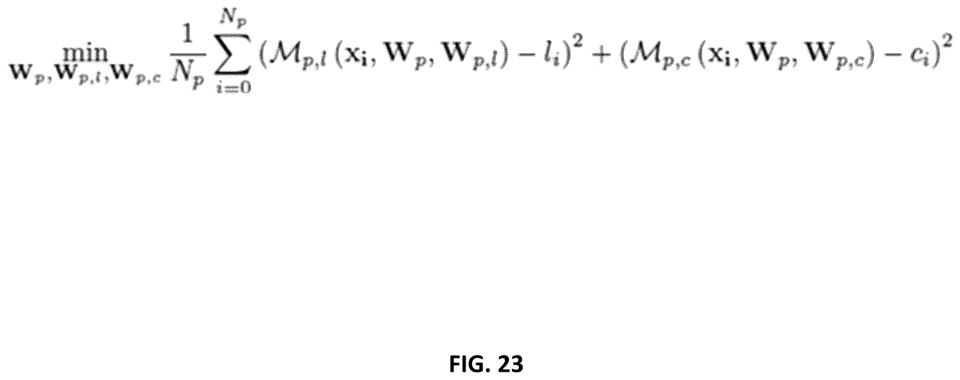

FIG. 23 shows a regression loss minimized by the technology disclosed.

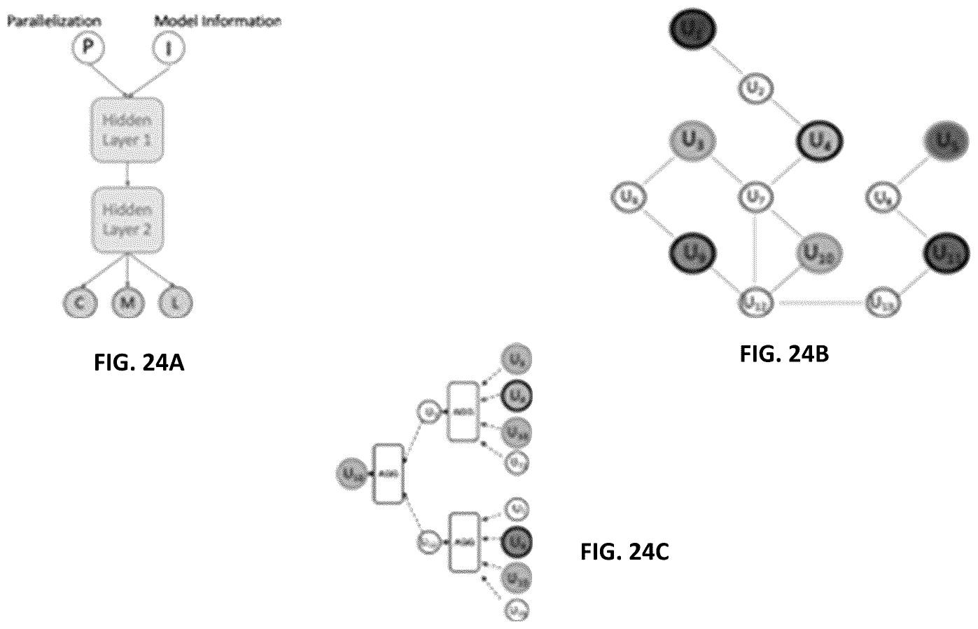

FIGS. 24a, 24b, and 24c show a coupling of the disclosed learned cost model with a simple nested binary search algorithm to solve the constrained parallelization allocation problem.

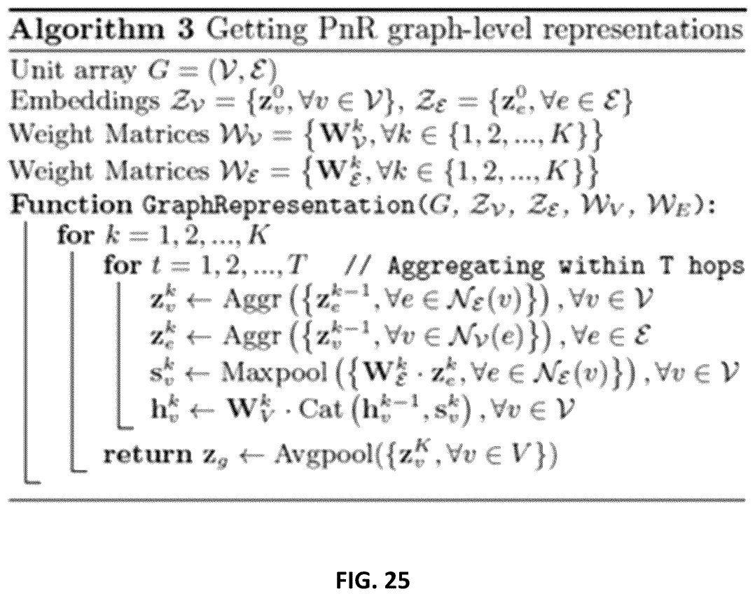

FIG. 25 shows use of a standard neighborhood aggregation methods to integrate information from the node and edge, which generates node-level representations zu∈Rdu.

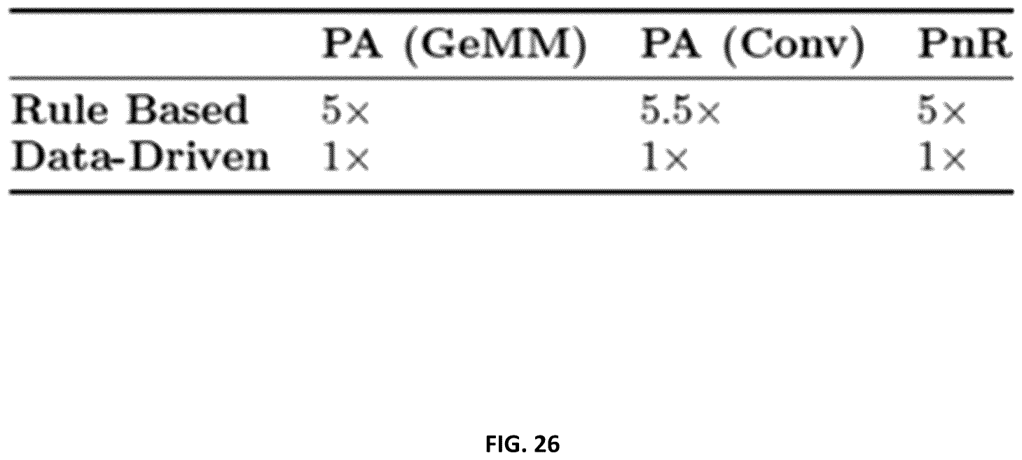

FIG. 26 illustrates Table 1: Engineering Time Required to Design Cost Model for PA and PnR in Months.

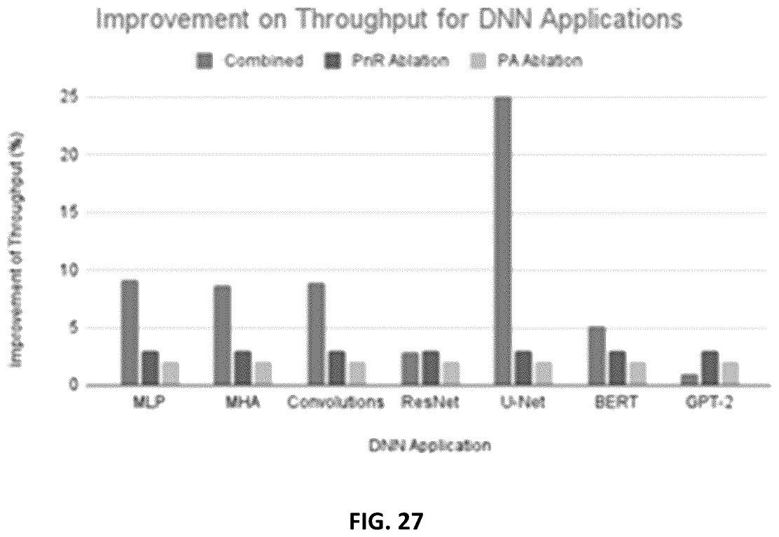

FIG. 27 shows Percent Throughput Improvement on Submodules and Full Modules.

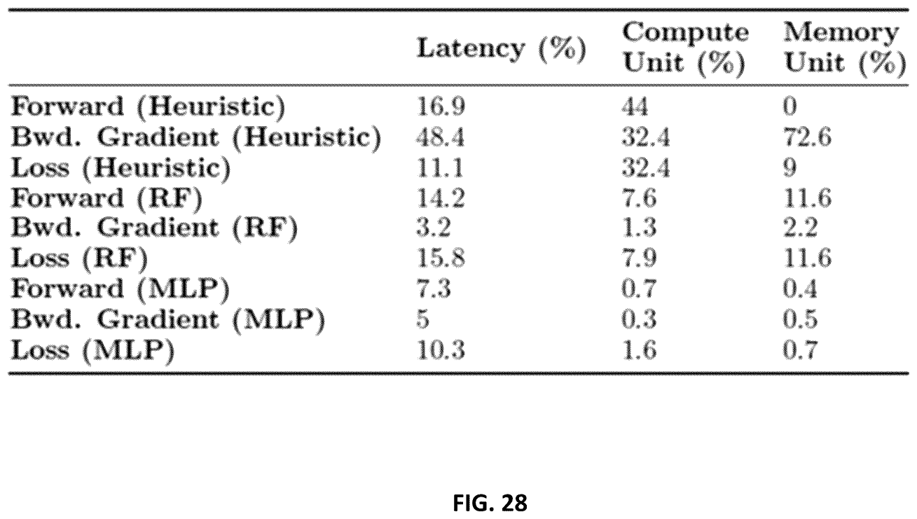

FIG. 28 illustrates Table 2: Prediction Error (Average Absolute Percentage Error) for GEMM operations.

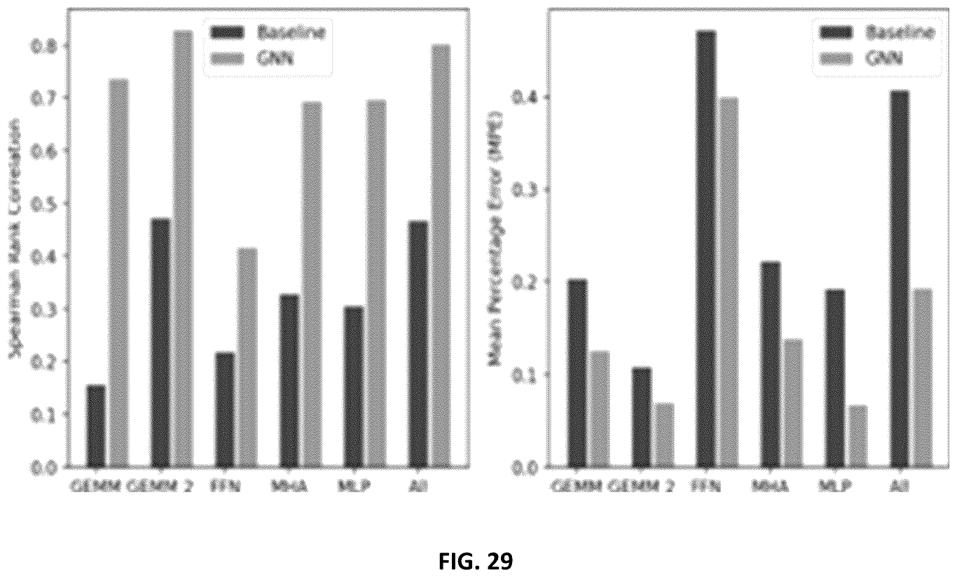

FIG. 29 depicts that the disclosed data-driven cost model for PnR is more accurate at predicting the throughput of spatial configurations for submodules such as FFN and MHA.

### Dataflow Architecture

As shown in FIG. 18a, the dataflow architecture comprises a large array of on-chip memory and compute units interconnected by fast communication fabrics within the chip. Comparing to the GPU architecture, this design enables magnitudes larger fast on-chip memory; this capacity is feasible by spatially accommodating the weights, activation and gradients associated with many operators which could enable a pipeline execution mode. In more details, we denote the set of compute and memory units by V={vi|i∈[NV]} where NV is the number of units. These units are connected by the set of communication fabrics E={ev,u|v∈V, u∈NV→V(v)} where NV→V(u) is the set of neighboring units connected to u. We use G=(V, E) to represent the array of units. Given a compute graph ^{˜}G=(^{˜}V, ^{˜}E), a dataflow compiler is required to spatially map the arithmetic operators in ^{˜}V={^{˜}vj|j␣[N^{˜}V]} to the hardware units in V and then route the operator connections ^{˜}E={e^{˜}v,^{˜}u|^{˜}v∈^{˜}V, ^{˜}u∈N^{˜}V→^{˜}V (^{˜}v)} through the communication fabric segments in E.

Pipeline Execution The spatial mapping between the compute graph and the array of units enables pipeline execution over operators. Specifically, when the training samples in a minibatch flow through the compute graph, an operator can process the second training sample while its immediate downstream operator is processing the first training sample as shown in FIG. 18b. Such an on-chip pipeline can achieve high training throughput due to two reasons. Firstly, when the samples flow through the pipeline, the model weights and the output of operators are stored in the on-chip memory units with magnitudes faster access than off-chip memory.

In addition, the compute units allocated for different operators can fire simultaneously to process different training samples, leading to a high utilization of the hardware compute capacity. To realize the mapping, compilers need to first determine how many units to allocated for each operator because an operator could be optionally paralleled across multiple units; we term this step as parallelization allocation. Given the units allocation, the compiler needs to perform placement and routing by identifying the preferable physical unit location of the units and connect the operators using selected fabrics.

### Parallelization Allocation

When making the parallelization allocation (PA) decisions, the goal of performance optimization flows is to find a proper unit count for each operator under the unit budget shared across the compute graph. On one hand, parallelizing an operator to more compute units can divide and conquer the overhead and reduce the processing latency. On the other hand, using more compute units for one operator potentially limits the degree of parallelization for other units; this can lead to insufficient compute units for accelerating the bottleneck operator. For the example in FIG. 18b, an over generous allocation for the Linear Layer imposes the ReLU layer to be the pipeline throughput bottleneck because the remaining units are not enough for sufficient parallelization. The key knob to this trade-off is called parallel factors which is the degree of input split for an operator. This knob is key to the PA stage because a fixed parallel factor value can fully determine the resource consumption. More formally, let li(pi)∈R, ci(pi)∈R be the latency and unit consumption of operator vi using parallel factor pi.

The goal of the parallelization allocation is to approximately solve the problem in Equation (1) for the minimal latency of the pipeline bottleneck operator without exceeding the number of available units.

Min max li(pi)s.t. p1,p2, . . . p|V|i=1,2, . . . ,|^{˜}V| Equation (1)

Unfortunately, the search space for this constrained problem is exponential with respect to the number of operators in the compute graph G. Specifically assuming that the maximal parallelization degree for operator vj∈V is Pj, we can see in FIG. 20 the size of the search space is [symbol] (Πᵢ₌₁^{|\tilde{V}|}Pᵢ).|.

### Spatial Placement And Routing

Under a fixed parallelization allocation decision, the placement and routing decision is required to associate compute graph operators and their connections with the physical location of units and communication fabrics respectively. Intuitively for a

$$𝒪 ( {\prod }_{j = 1}^{\vert \hat{𝒱} \vert} ( \begin{matrix}\vert 𝒱 \vert - \sum \text{?} {α}_{k} \\ {a}_{j}\end{matrix} )$$

$$\text{?} \text{indicates text missing or illegible when filed}$$

PnR decision granting high training throughput, neighboring operators tend to sit on nearby units which reduce the data communication time between these operators. Additionally, a preferable PnR decision should avoid associating too many operator connections to a single communication fabric, so that the data flows on the fabrics without congestion. Such ideal PnR decisions unfortunately need to be picked from an exponentially large search space. Assuming an operator ^{˜}vj∈^{˜}V in compute graph ^{˜}G is assigned aj

$$𝒪 ( {\prod }_{j = 1}^{\vert \hat{𝒱} \vert} ( \begin{matrix}\vert 𝒱 \vert - \sum \text{?} {n}_{b} \\ {a}_{j}\end{matrix} )$$

$$\text{?} \text{indicates text missing or illegible when filed}$$

units, there are options when sequentially associating each operator to the unit set V. At the routing stage an inter-operator connection can choose to include each individual fabric e∈E or not, leading to 2|W| possibilities. These facts imply an overall search space size for PnR as shown in FIG. 20 where E is the set of operator connections in compute graph ^{˜}G.

### Rule-Based Performance Optimization

Given the large search space for the two decision problems in dataflow performance optimization, it is practically infeasible to perform exhaustive trial on all the possible mappings from a compute graph to units. This is due to the fact that the accumulated time cost of exhaustive trial substantially exceeds the user expectation on compile time. To solve this issue, the industrial production compilers use hand-tuned rules to guide the mapping search. As a concrete example, a common rule for Linear Operators is that “the fitness score is non-linear function of the input dimension, clock frequency, and the number of units assigned. In the PnR stage, one preeminent example of the rule is “punishing decisions with edges that are assigned more data in the pipeline to transmit than can be done on one clock cycle.”

### Learned Performance Optimization

With the goal of higher throughput at lower engineering cost, we prototype a two-stage workflow for performance optimization guided by simple machine learning models. We briefly discuss the framework for developing the workflow from random mappings and empirical throughput observations. We then introduce the specific simple machine learning models which act as the workhorse for PA and PnR in our data-driven workflow. Specifically, in the Learned Performance Optimization Section.2 we present a simple multilayer perceptron (MLP) model for PA to determine the number of allocated units for each compute graph operators. In the Learned Performance Optimization section, we introduce a graph neural network to encode PnR mappings which guides the search as a cost model.

Despite the fact that these rule-based performance optimization workflows are already deployed in industrial production, there are still two major challenges to fully unleash the hardware advantage of the dataflow architecture. Firstly, rule-based PO workflows require immense engineering time from domain expert to develop upgrading the rules upon software and hardware stack evolution is also time intensive. Secondly, for the compute graph in many unseen model variations, the rule-based workflow was still observed to have 25% throughput gap towards manual expert mapping in transformer model variations for example. This is due to the fact that there are infinitely many compute graph variations while it is hard to encode all the possible subtleties using a finite set of hand-tuned rules. These two challenges motivated us to explore learned performance optimization workflows for better training throughput at reduced engineering cost.

### Development Framework

At the core of learned performance optimization, we use data-drive cost models instead of hand-tuned rules to guide the search for key decision variables for mapping compute graph to the unit arrays. As discussed in The Preliminary Section, these key variables are 1) parallel factors in the parallelization allocation stage and 2) the physical locations of unit and fabric in the placement and routing stage. To develop cost models to evaluate the fitness of different variable values, we collect a large volume of triplets consisting of compute graphs, mapping decision variable values and their corresponding cost observations as the training data. Under this framework, the triplets can be sampled using any blackbox that could cover a large enough compute graph and decision variables space. Build on top of these triplets data, our workflow learns the cost models using straightforward supervised training. To expose the specific development methodologies for the PA and PnR cost models, we further elaborate on the triplets for the two mapping stages respectively.

### Parallelization Allocation Triplets

In the PA stage, different parallel factors can consume drastically different number of compute and memory units for the same individual operator. This exposed a trade-off space for search algorithms between latency and resource usage. For instance, properly partitioning a matrix multiplication along the input dimension could accelerate the compute but grabs units from potential latency-bottleneck operators. This intuition leads to our natural design of the PA cost model as discussed in FIG. 22. In this design the model predicts the units' consumption and the execution latency to expose rich information for smart search algorithm exploiting the trade-off space. These predictions derive from a single input operator oi∈O as a one-node compute graph where O is the operator space; this is accompanied by a scalar parallel factor pi∈R as the decision variable value. Note here we assume the operator space O covers a wide variations of operator types and configurations such as input dimensions. Such variations provide the data basis for generality across operator configurations.

In contrast to the single operator graph in the PA triplet, we train the PnR cost model using model building block level compute graphs; this enables the PnR cost model to handle compute graphs with complex operator connections. Given each sampled compute graph bj in FIG. 22, a PnR cost model solely focuses on learning the mapping from operator and connection to units and fabrics. Thus, to ensure sufficient input to cost model, we augment each sampled compute graph bj with a sampled parallel factor configuration pj∈P(bj)⊂R|Vj| where P (bj) is the space of all possible parallel factor configurations for bj. The decision variables on this augmented compute graph consists of two mapping functions. Let Sv (U) enumerate all the subset of units, the first function f: Vj 7→Sv (U) maps an operator to a set of allocated units where the number of units is induced by the sampled parallel factor. After the operators are physically mapped, the second function g: Ej 7→Se (W) maps the inter-operator connections to a set of communication fabric segments. Note g returns a set of fabric segments because it may require multiple fabric segment hop to transfer data from a source unit to its target. Using the above input setup, the PnR cost model learns to predict the execution latency of compute graphs given a specific parallel factor setup.

### Learned Parallelization Allocation

After collecting the PA triplets data for operator oi, we first encode the parallel factor and operator configurations such as input dimensions into a real-value feature vector xi∈Rdp. Using the feature vectors as the model input, we train a multilayer perception (MLP) model to predict the latency and unit consumption of an operator using a specific parallel factor. Model training For the simplicity of the modeling, we use the same MLP backbone for predicting the latency and the unit consumption as shown in FIG. 21a. Let Wp be weight of the common backbone while Wp,c,Wp,l are latency and unit consumption specific weights respectively for the final linear projection layer. We denote the latency and unit consumption predictions as Mp,l (xi,Wp,Wp,l) and Mp,c (xi,Wp,Wp,c). When training on the dataset Dp as shown in FIG. 22, we use stochastic gradient descent to minimize FIG. 23's regression loss.

Search Integration We use this trained MLP model as a drop-in replacement of conventional cost models based on hand-tuned rules for parallelization allocation. When integrating with the full compiler workflow, we couple our learned cost model with a simple nested binary search algorithm to solve the constrained parallelization allocation problem in Equation (1). Specifically, the outer loop of the binary search iterates on the latency upper bound. Meanwhile the inner loop binary-search the smallest parallel factors for each operators so that 1) the operator latency is smaller than the upper bound and 2) the sum of per-operator unit consumption is not exceeding the capacity of available units

### Learned Placement And Routing

With MLP-guided binary search in the Learned Performance Optimization section granting the parallel factor values, the PnR decision remains on how to allocate each compute and memory unit to different operators, as well as which switch and fabric segments, we use to transfer the and then use a graph neural network to extract a graph level representation. This graph neural network predicts the throughput of models compiled with the specific PnR decision; it acts as the cost model guiding the search for preferred PnR decisions.

Encoding As shown in FIG. 21b, we encode each utilized compute, memory, and switch units v∈V as a node in the graph representation. These nodes are encoded by a embedding vector z0 v∈Ru, which consists information such as operator types, unit types and operator sizes. When connecting the nodes in the graph representation, each edge associates to a communication fabric segment. For an edge e∈E which corresponds to a fabric segment, we use a edge embedding vector z0∈Rde to provide relevant characteristics such as the type of connected units and operators. As discussed in FIG. 25, we use a standard neighborhood aggregation method to integrate information from the node and edge, which generates node-level representations zu∈Rdu. We derive the graph-level representation zg∈Rdg using average pooling from node-level representation.

Model training to construct the cost model for PnR decision search, we build a simple linear regression layer on top of the graph-level representation extracted in FIG. 25. We jointly train the set of graph neural network weights WV and WE, as well as the weight of the linear regressor using the PnR triplet data Dp.

Search integration When compiling a compute graph, we use this GNN-based regression model to guide the search in a simulated annealing algorithm. Specifically, we extract the graph-level representation for PnR decisions as discussed in FIG. 25 and then use the predicted throughput from the linear regressor as a cost model to evaluate the different sampled PnR decisions in the simulated annealing algorithm.

### Experiments

This section shows the engineering time savings and accuracy improvements gained from our methodology over standard rule-based cost models. We begin by presenting empirical improvements in accuracy and engineering time gained by using the MLP as a cost model for PA and using the GNN and its associated MLP for the second phase (PnR). The benefits of just the data-driven PA approach without the associated data-driven PnR is shown later in this Application, while the benefits of just the data-driven PnR approach are presented in a subsequent ablation study section.

### Experimental Metrics

For all three studies presented, we use the same metrics to show the impact of data-driven PA and PnR individually as well as acting together. First, prediction accuracy (measured as percentage prediction error) of the PA and PnR machine learning models with respect to the true values is compared with that of the baseline, an industry-standard rule-based heuristic PA and PnR discussed later in this Application. The PnR process predicts throughput (measured in cycles per second as industry standard for a given placement and routing, while PA predicts latency and resource utilization for the given parallelization. Second, approximate engineering time (measured in months as per industry standard (Chi et al., 2018)) is presented for the data driven approach and the rule-based approach, collecting internal estimates of the design times for the rule-based cost models, and comparing them with the design times for the learned cost models. Lastly, we provide the Spearman Rank Correlation metric in the case of PnR ablation studies (Section 4.3) to analyze the ability of the cost model to compare 2 spatial configurations.

### Learned Model Hyperparameters

These data driven cost models for PA and PnR in the studies presented below was done with the following hyperparameters. In the MLP for PA, we encode the inputs as a vector of dimension 10 with 7 hidden layers. This structure is large enough to learn correlations between the inputs effectively while also small enough to train in less than 2 hours. For PnR, aiming for a model that can effectively learn correlations between inputs while also being quick to train, we use a ten-layer GNN (K=10) where each intermediate weight matrix is a dense linear network. The MLP placed after the GNN regressor consists of 3 linear matrices.

### Data-Driven Cost Models Together

The goal of this experiment is to demonstrate that using both learned cost models together drive improvements in throughput while also decreasing the engineering time requirement. To test our learned cost model's effect on throughput, we compile several submodules including Convolution, GeMM, MHA and FFN and several key DNN applications such as BERT, ViT, GPT-2, and ResNet with different SA parameters, totaling 2096 different datapoints. This is done using a single learned cost model trained only on submodules and the baseline cost models.

### Throughput Improvements

From FIG. 27, we see that using the learned cost model increases throughput by an average of 8% over the baselines on submodules (averaging throughput increases over many configurations). Our learned cost models thus deliver meaningful improvements to the most important metric, the final throughput of the compiled model. As shown, that learned cost model can also generalize to larger DNN applications, improving throughput by an average of 5%. This demonstrates the practical throughput improvement gained from using these learned cost models for training deep learning models on the dataflow architecture.

### Engineering Time Savings

The engineering time savings over traditional rule based cost models are immense. On average, using learned cost models reduces the engineering time requirement by 79% for PA and 80% for PnR. Furthermore, given the generalization results of Section 4.1, it is evident that we do not need to redesign cost models for compiling different DNN applications. Instead, quickly collecting training datasets on fundamental submodules is enough. Consequently, the additional engineering time requirements for designing learned cost models for full DNN models is no more than that of the submodules. To examine the importance of each cost model to these improvements, we now examine the improvements driven by each of the cost models (PA and PnR) in individual ablation studies.

### PA Ablation

This ablation analyzes the use of the MLP for the first task of PO, PA. The conventional PA cost model from 2.4 acts as a baseline. We demonstrate improvements with respect to this baseline, recording metrics on the widely used General Matrix Multiply (GeMM) and 2D Convolution operators. To accurately compare data driven PA with the baseline, a testing dataset that covers the tasks seen in practical DNN applications is required. This is done by collecting the exhaustive list of parallelization for each operator, varying the operator's layer configurations and input dimensions. These testing datasets contained 21,098 datapoints.

### Results

The results of isolated PA experiments using the testing dataset we built are shown in Table 2. As is evident, using the learned cost model delivered improvements in engineering time as well as prediction accuracy improvements for resource unit usage, memory unit usage, and latency. The prediction error for the MLP improved on average by 27.9%1 over the baseline cost models.

### PnR Ablation

After showing the benefits of using learned cost models for PA, we now do the same for PnR. A baseline for the metrics collected here is provided by the rule-based cost model for PnR. To test these cost models, we create two testing datasets: one from PnR decisions from submodules and one from PnR decisions from several practical DNN applications, including BERT, ViT, U-Net, ResNet, and GPT-2. Each dataset contains 528 datapoints, each a spatial configuration generated by fully compiling each model with different search hyperparameters to generate a testing dataset that is representative of the tasks the cost model will see in practice.

FIG. 29 shows the results of this PnR ablation study. As we see in the figure, using the learned cost model trained on the submodules yields an improvement in accuracy of 39%. This demonstrates that our learned cost model for PnR can save engineering time while being more accurate than the baseline rule-based cost model. Moreover, the learned cost model trained on submodules still delivers an improvement of 11% accuracy as a PnR cost model when tested on DNN applications, demonstrating that a learned cost model trained on only small submodules can be a more accurate cost model than the rule-based cost standard on even larger DNN applications.

Our data-driven cost model for PnR is more accurate at predicting the throughput of spatial configurations for submodules such as FFN and MHA. In terms of Mean Percentage Error, the learned cost model is on average 42% more accurate than the baseline rule-based cost model. In addition to the error, the learned cost model demonstrates an improvement of 121% in terms of the Spearman Rank Correlation over rule-based cost models, meaning that the learned cost model is also more accurate at comparing different spatial configurations.

### Conclusion

An accurate model to predict resource and latency in RA stage is critical to dataflow compiler. Inferior runtime throughput can be caused by either over-reporting resources in the model which leads to hardware under-utilization at runtime or caused by inaccurate latency estimation which leads to imbalanced pipeline. Complete compilation failure is caused by under-reported resources in the model which prompts RA to generate aggressive PDs that exceeds the available hardware resources. The imprecision of heuristics can preclude PnR decisions that are empirically performant but discouraged under simplified heuristics. For example, a heuristic that simply sums up the bandwidth of overlapped routes can overestimate the routing congestion due to the time-division multiplexing communication patterns that could happen in practice.

The architecture, configurability, and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

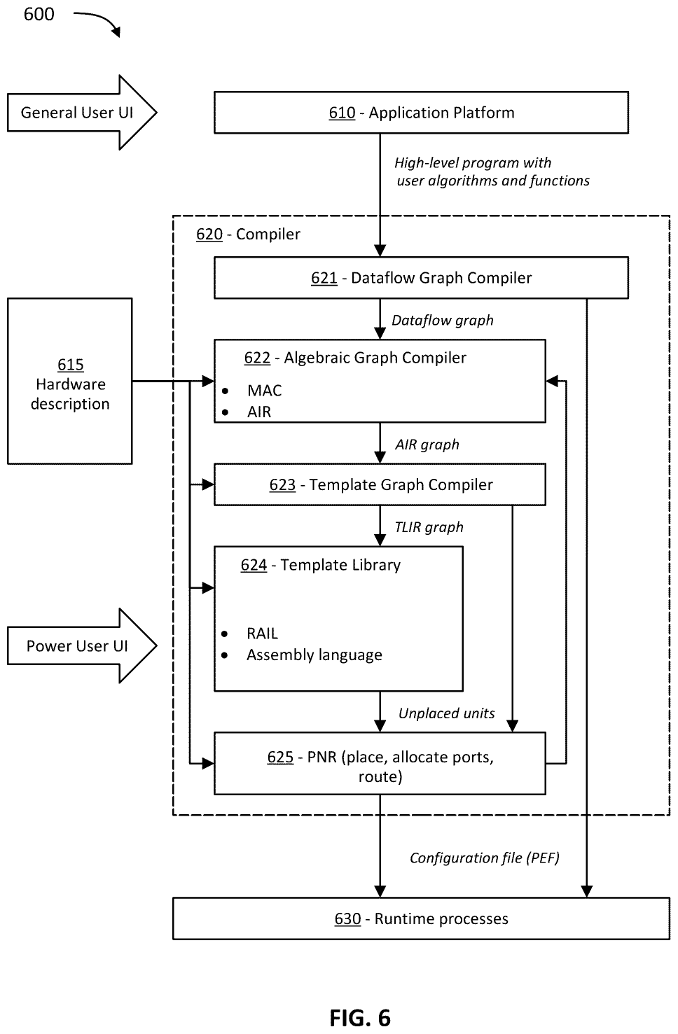

Translation of high-level programs to executable bit files is performed by a compiler, see, for example, FIGS. 6-11. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

### Implementations

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

Translation of high-level programs to executable bit files is performed by a compiler, see, for example, FIGS. 6-11. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

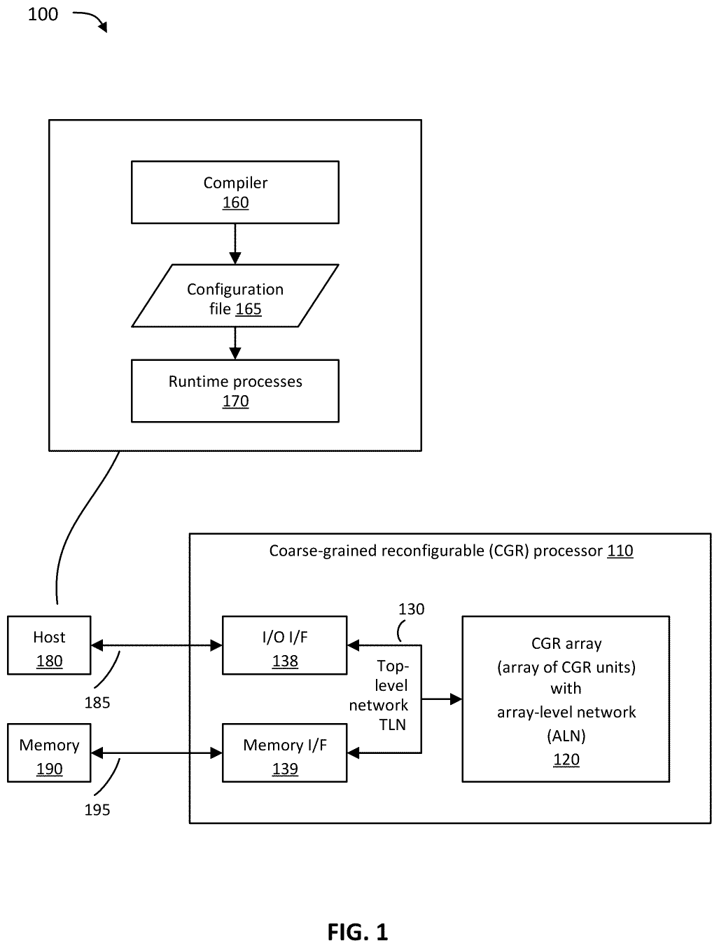

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via databus 130 which may be part of a top-level network (TLN). Host 180 communicates with IO interface 138 via system databus 185, and memory interface 139 communicates with memory 190 via memory bus 195. Array of CGR units 120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

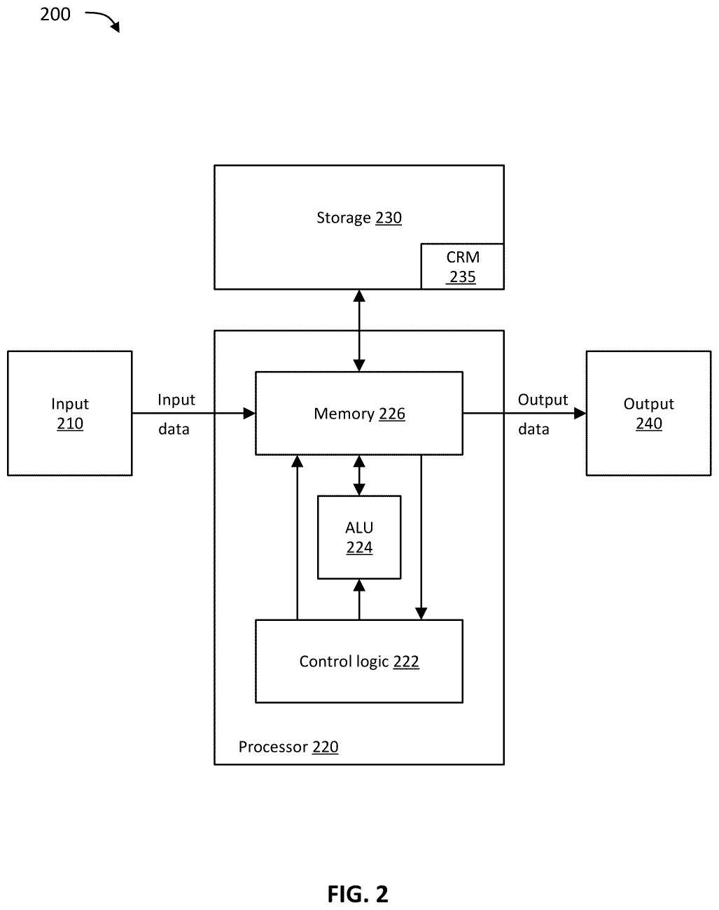

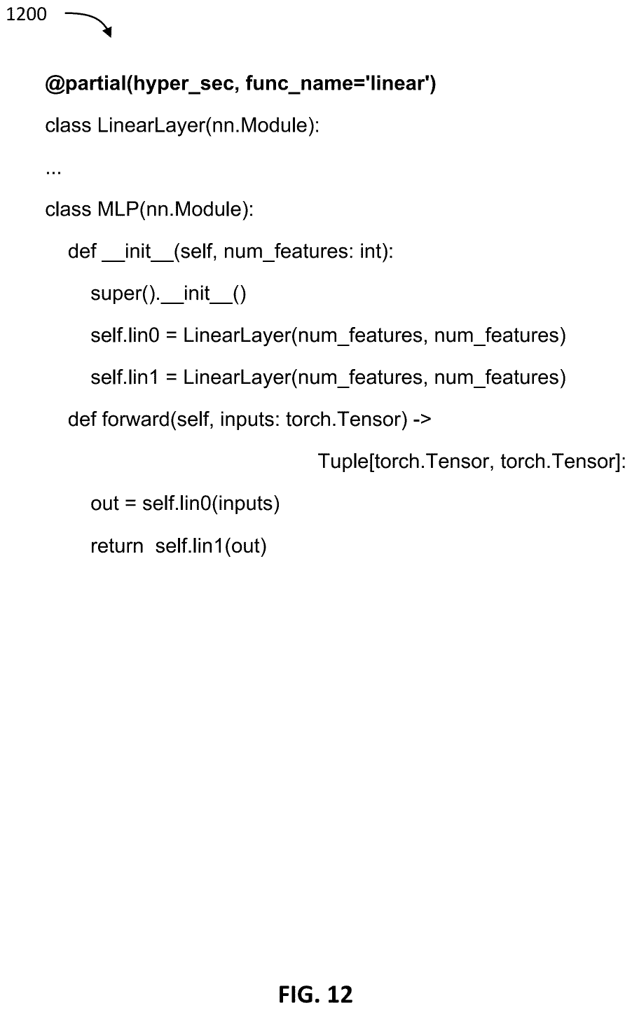

Host 180 may be, or include, a computer such as further described with reference to FIG. 2. Host 180 runs runtime processes, as further referenced herein, and may also be used to run computer programs, such as the compiler 160 further described herein with reference to FIG. 12. In some implementations, the compiler may run on a computer that is similar to the computer described with reference to FIG. 2, but separate from host 180.

CGR processor 110 may accomplish computational tasks by executing a configuration file 165 (for example, a PEF file). For the purposes of this description, a configuration file corresponds to a dataflow graph, or a translation of a dataflow graph, and may further include initialization data. A compiler 160 compiles the high-level program to provide the configuration file 165. Runtime processes 170 may install the configuration file 165 in CGR processor 110. In some implementations described herein, a CGR array is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the computation graph to the CGR array 120. Execution of the configuration file by CGR processor 110 causes the CGR array 120 to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

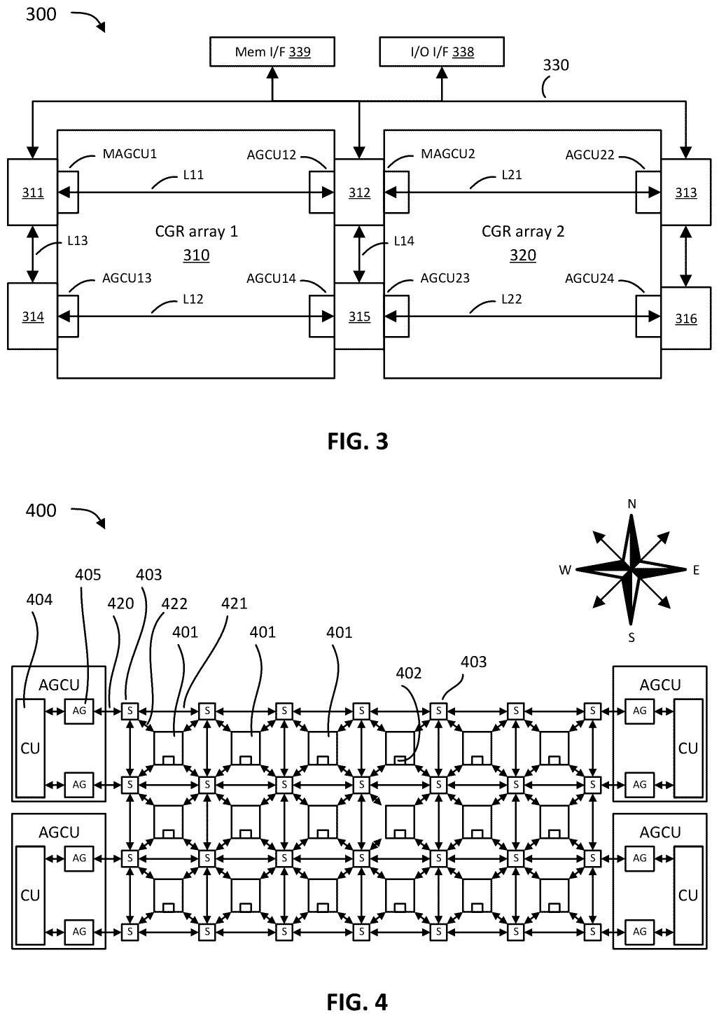

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., MAGCU1, AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, and external I/O interface 338. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

FIG. 4 illustrates an example CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017, Jun. 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 401 may have four ports (as drawn) to interface with switch units 403, or any other number of ports suitable for an ALN. Each port may be suitable for receiving and transmitting data, or a port may be suitable for only receiving or only transmitting data.

A switch unit, as shown in the example of FIG. 4, may have eight interfaces. The North, South, East and West interfaces of a switch unit may be used for links between switch units using interconnects 421. The Northeast, Southeast, Northwest and Southwest interfaces of a switch unit may each be used to make a link with an FCMU, PCU or PMU instance using one of the interconnects 422. Two switch units in each CGR array quadrant have links to an AGCU using interconnects 420. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 5 illustrates an example 500 of a PMU 510 and a PCU 520, which may be combined in an FCMU 530. PMU 510 may be directly coupled to PCU 520, or optionally via one or more switches. PMU 510 includes a scratchpad memory 515, which may receive external data, memory addresses, and memory control information (write enable, read enable) via one or more buses included in the ALN. PCU 520 includes two or more processor stages, such as SIMD 521 through SIMD 526, and configuration store 528. The processor stages may include ALUs, or SIMDs, as drawn, or any other reconfigurable stages that can process data.

Each stage in PCU 520 may also hold one or more registers (not drawn) for short-term storage of parameters. Short-term storage, for example during one to several clock cycles or unit delays, allows for synchronization of data in the PCU pipeline.

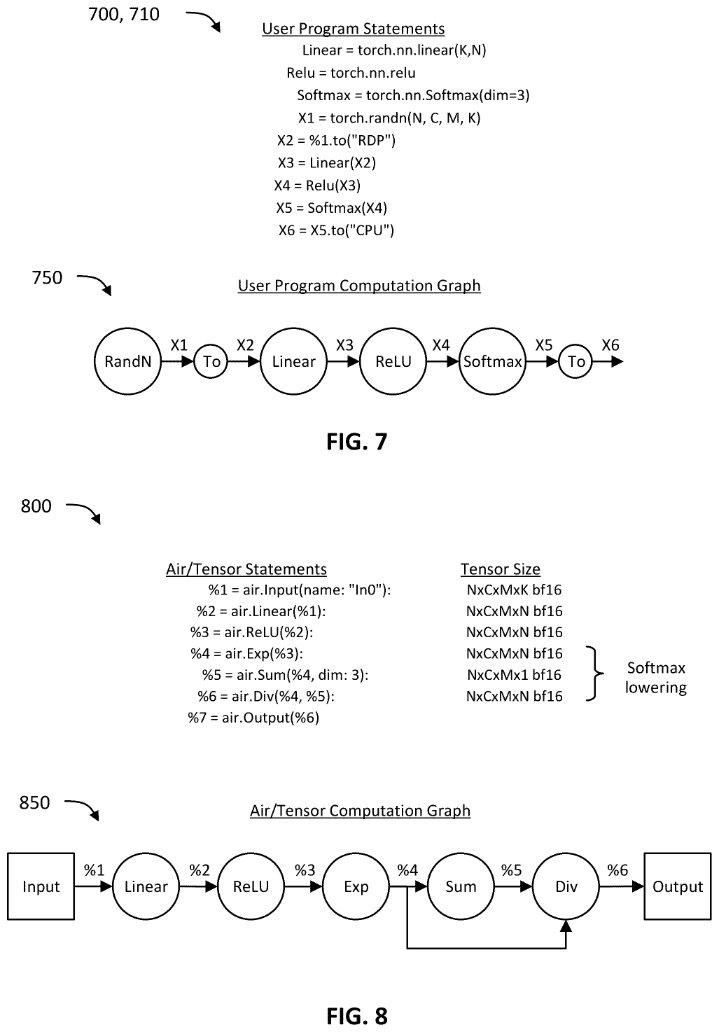

FIG. 6 is a block diagram of a compiler stack 600 implementation suitable for generating a configuration file for a CGR processor. FIGS. 7-11 illustrate various representations of an example user program 700 corresponding to various stages of a compiler stack such as compiler stack 600. As depicted, compiler stack 600 includes several stages to convert a high-level program (e.g., user program 700) with statements 710 that define user algorithms and functions, e.g., algebraic expressions and functions, to configuration data for the CGR units. The example user program 700 depicted in FIG. 7 comprises statements 710 that invoke various PyTorch functions.

Compiler stack 600 may take its input from application platform 610, or any other source of high-level program statements suitable for parallel processing, which provides a user interface for general users. It may further receive hardware description 615, for example defining the physical units in a reconfigurable data processor or CGRA processor. Application platform 610 may include libraries such as PyTorch, TensorFlow, ONNX, Caffe, and Keras to provide user-selected and configured algorithms.

Application platform 610 outputs a high-level program to compiler 620, which in turn outputs a configuration file to the reconfigurable data processor or CGRA processor where it is executed in runtime processes 630. Compiler 620 may include dataflow graph compiler 621, which may handle a dataflow graph, algebraic graph compiler 622, template graph compiler 623, template library 624, and placer and router PNR 625. In some implementations, template library 624 includes RDU abstract intermediate language (RAIL) and/or assembly language interfaces for power users.

Dataflow graph compiler 621 converts the high-level program with user algorithms and functions from application platform 610 to one or more dataflow graphs. The high-level program may be suitable for parallel processing, and therefore parts of the nodes of the dataflow graphs may be intrinsically parallel unless an edge in the graph indicates a dependency. Dataflow graph compiler 621 may provide code optimization steps like false data dependency elimination, dead-code elimination, and constant folding. The dataflow graphs encode the data and control dependencies of the high-level program. Dataflow graph compiler 621 may support programming a reconfigurable data processor at higher or lower-level programming languages, for example from an application platform 610 to C++ and assembly language. In some implementations, dataflow graph compiler 621 allows programmers to provide code that runs directly on the reconfigurable data processor. In other implementations, dataflow graph compiler 621 provides one or more libraries that include predefined functions like linear algebra operations, element-wise tensor operations, non-linearities, and reductions required for creating, executing, and profiling the dataflow graphs on the reconfigurable processors. Dataflow graph compiler 621 may provide an application programming interface (API) to enhance functionality available via the application platform 610.

FIG. 7 shows an example user program 700 in an example first stage of the compiler stack. User program 700 generates a random tensor X1 with a normal distribution in the RandN node. It provides the tensor to a neural network cell that performs a weighing function (in the Linear node) followed by a rectified linear unit (ReLU) activation function, which is followed by a Softmax activation function, for example to normalize the output to a probability distribution over a predicted output class. FIG. 7 does not show the weights and bias used for the weighing function. User program 700 corresponds with computation graph 750.

Algebraic graph compiler 622 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 622 may also transform the graphs via autograd and gradient normalization, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 622 may further include an arithmetic or algebraic intermediate representation (AIR) level that translates high-level graph and mapping decisions provided by the MAC level into explicit AIR/Tensor statements 800 (see FIG. 8) and one or more corresponding algebraic graphs 850. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 8 shows the user program 700 in an example second stage of the compiler stack. At this stage, the algebraic graph compiler replaces the Softmax macro by its constituents. The Softmax function is given as

$$\frac{{e}^{\{ {z}_{i} \}}}{{\sum }_{j = 1}^{K} {e}^{\{ {z}_{j} \}}} .$$

This function includes an exponential component, a summation, and a division. Thus, algebraic graph compiler 622 replaces the user program statements 710, also shown as computation graph 750, by AIR/Tensor statements 800, also shown as Air/Tensor computation graph 850.

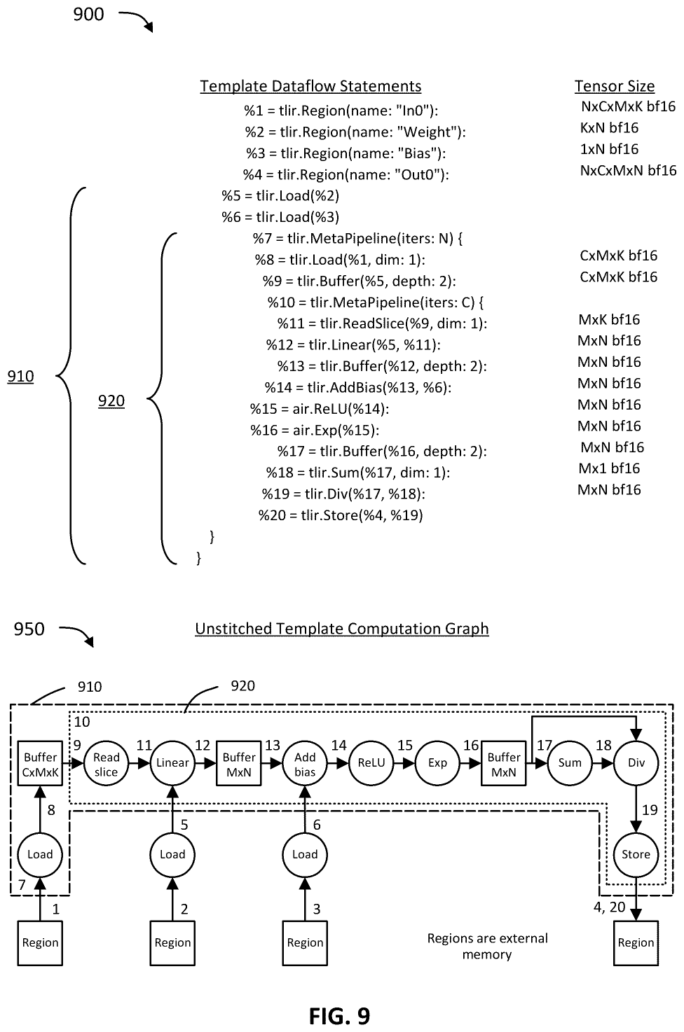

Template graph compiler 623 may translate AIR statements and/or graphs into TLIR statements 900 (see FIG. 9) and/or graphs (graph 950 is shown), optimizing for the target hardware architecture into unplaced variable-sized units (referred to as logical CGR units) suitable for PNR 625. Template graph compiler 623 may allocate metapipelines, such as metapipeline 910 and metapipeline 920, for sections of the template dataflow statements 900 and corresponding sections of unstitched template computation graph 950. Template graph compiler 623 may add further information (name, inputs, input names and dataflow description) for PNR 625 and make the graph physically realizable through each performed step. Template graph compiler 623 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

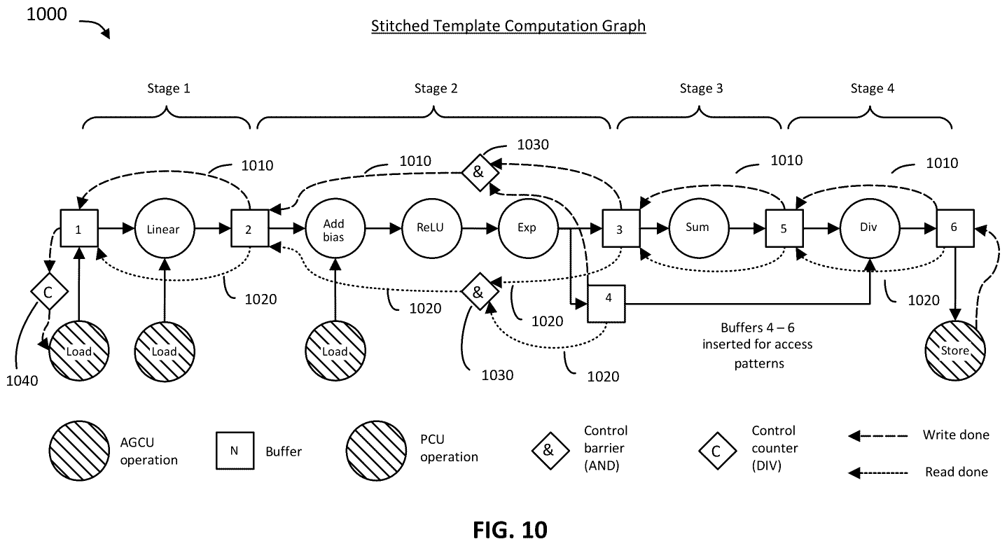

FIG. 10 shows the user program 700 in an example fourth stage of the compiler stack. The template graph compiler 623 may also determine the control signals 1010 and 1020, as well as control gates 1030 and 1040 required to enable the CGR units (whether logical or physical) to coordinate dataflow between the CGR units in the CGR array of a CGR processor. This process, sometimes referred to as stitching, produces a stitched template compute graph 1000 with control signals 1010-1020 and control gates 1030-1040. In the example depicted in FIG. 10, the control signals include write done signals 1010 and read done signals 1020, and the control gates include ‘AND’ gates 1030 and a counting or ‘DIV’ gate 1040. The control signals and control gates enable coordinated dataflow between the configurable units of CGR processors such as compute units, memory units, and AGCUs.

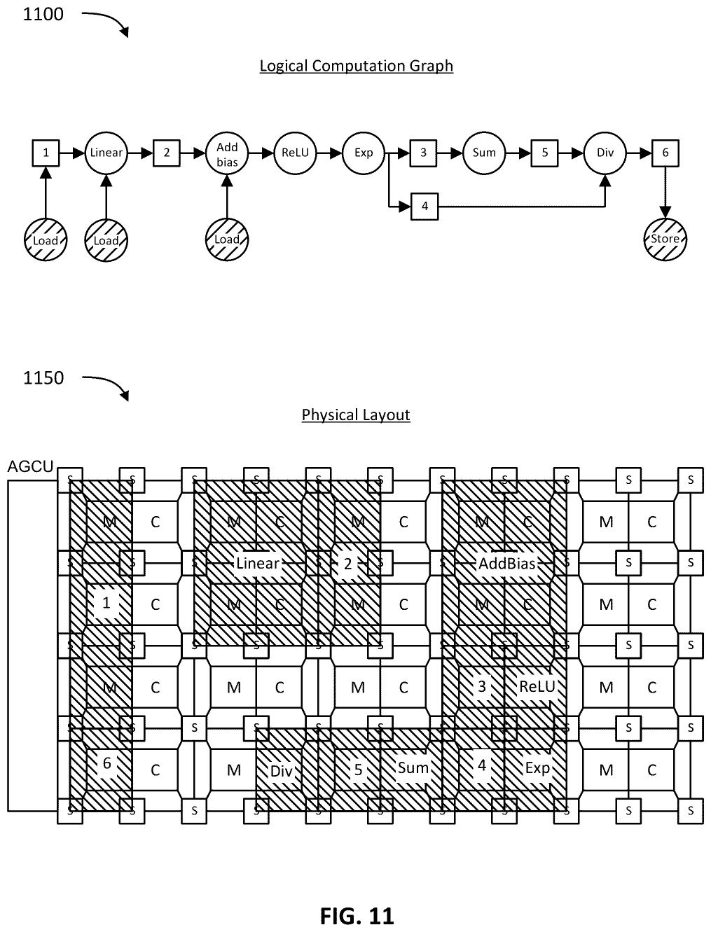

PNR 625 translates and maps logical (i.e., unplaced physically realizable) CGR units (e.g., the nodes of the logical computation graph 1100 shown in FIG. 11) to a physical layout (e.g., the physical layout 1150 shown in FIG. 11) on the physical level, e.g., a physical array of CGR units in a semiconductor chip. PNR 625 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 625 may provide its functionality in multiple steps and may include multiple modules (not shown in FIG. 6) to provide the multiple steps, e.g., a placer, a router, a port allocator, and a PEF file generator. PNR 625 may receive its input data in various ways. For example, it may receive parts of its input data from any of the earlier modules (dataflow graph compiler 621, algebraic graph compiler 622, template graph compiler 623, and/or template library 624). In some implementations, an earlier module, such as template graph compiler 623, may have the task of preparing all information for PNR 625 and no other units provide PNR input data directly.

Further implementations of compiler 620 provide for an iterative process, for example by feeding information from PNR 625 back to an earlier module, so that the earlier module can execute a new compilation step in which it uses physically realized results rather than estimates of or placeholders for physically realizable circuits. For example, PNR 625 may feed information regarding the physically realized circuits back to algebraic graph compiler 622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 620 binds memory allocations to unplaced memory units and binds operations specified by operation nodes in the dataflow graph to unplaced compute units, and these bindings may be specified in the configuration data. In some implementations, compiler 620 partitions parts of a dataflow graph into memory subgraphs and compute subgraphs, and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 11 shows the logical computation graph 1100 and an example physical layout 1150 of the user program.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUs), FPGAs, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

FIG. 12 shows an example of pseudocode 1200 to define a hypersection. “hyper_sec” is used to indicate that a hypersection with the name “linear” is being defined.

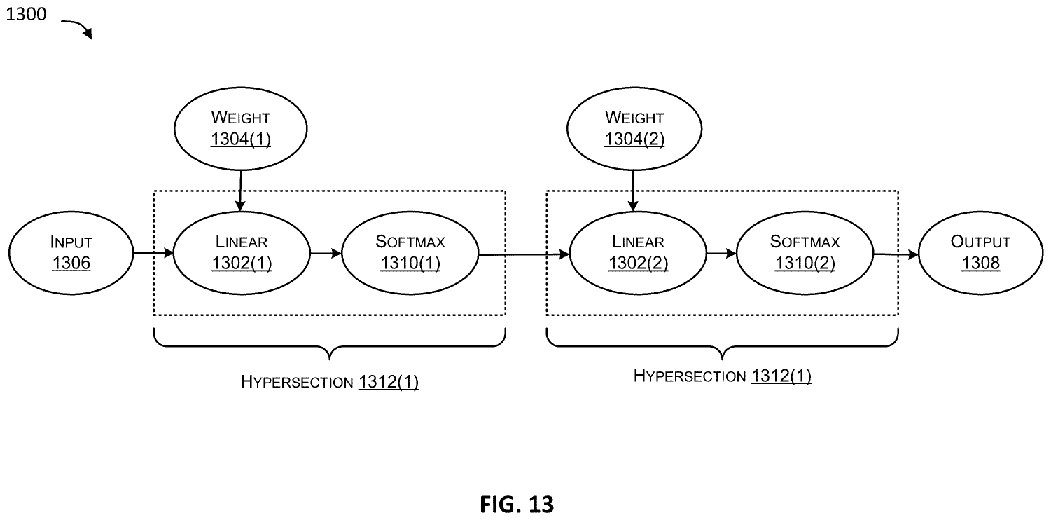

FIG. 13 shows a logical computation graph 1300 that includes 2 sections that will be used to create 2 hypersections. A section 1302(1) called “linear” receives input 1306 and a weight 1304(1) to produce softmax 1310(1). The section 1302(1) and the softmax 1310(1) are used to create a hypersection 1312(1). A section 1302(2) has the same code as section 1302(1) and takes input softmax 1310(1) and weight 1304(2) to produce softmax 1310(2) which is provided as output 1308. The section 1302(2) and the softmax 1310(2) are used to create a hypersection 1312(2).

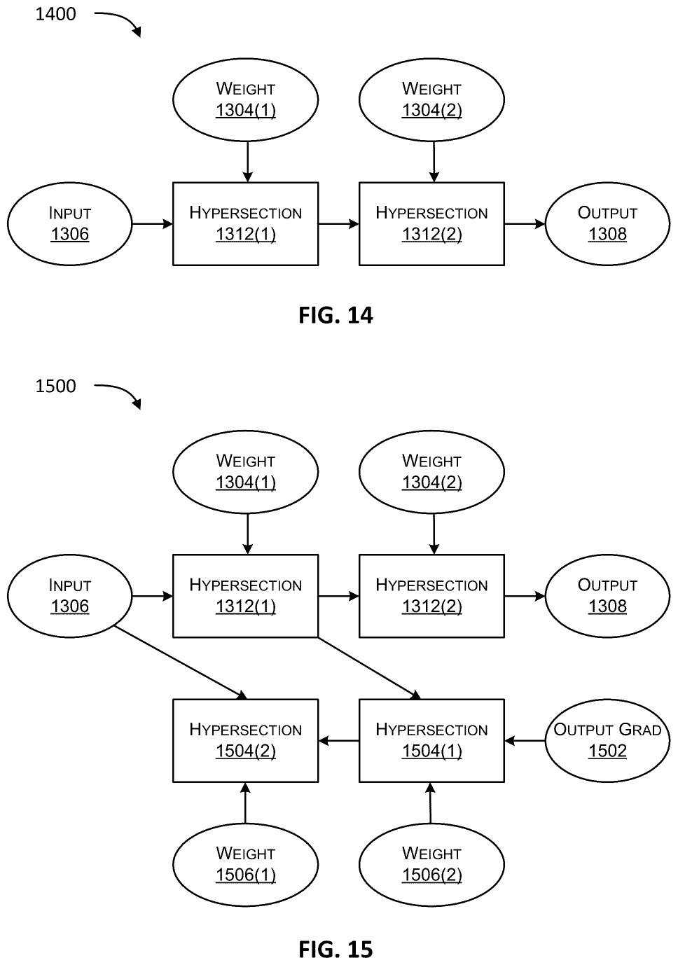

FIG. 14 illustrates executing a logical computation graph 1400 in which a hypersection is executed twice. In FIG. 14, hypersection 1312(1) processes input 1306 using weight 1304(1) and sends its output to hypersection 1312(2). Hypersection 1312(2) processes the output of hypersection 1312(1) as input using weight 1304(2) and provides output 1308.

FIG. 15 illustrates executing a logical computation graph 1500 in which two unique hypersections are each executed twice. In FIG. 15, hypersection 1312(1) processes input 1306 using weight 1304(1) and sends its output to hypersection 1312(2). Hypersection 1312(2) processes the output of hypersection 1312(1) as input using weight 1304(2) and provides output 1308.

Output gradient 1502, the output of hypersection 1312(1), and weight 1506(2) are used by hypersection 1504(1) to produce an output that is provided as input to hypersection 1504(2). Hypersection 1504(2) uses the output of hypersection 1504(1) and weight 1506(1).

Gradient involves calculating a gradient (which adjusts a weight of output by a delta) for parameters. In some cases, hypersections may be back propagated, e.g., a backward graph compared to a previous step that was a forward graph. previous step (fwd graph). Hypersection 1504(1) is backwards of hypersection 1312(1).

Some languages, such as Python, are interpreted. The interpreter takes a line of code, executes it, fetches a next line of code and so on. The interpreter sees a linear sequence of operations that are executed one after another.

Hyper section compile (HSC) is used to gain two advantages. First, HSC increases compilation speed. Large natural language models, such as natural language processing (NLP), generative pre-trained transformer (GPT) and the like are large models that take a lot of time to compile, typically tens of hours for the compiler to generate bitfiles. Using HSC significantly reduces compile time.

Second, HSC divides application into multiple segments to enable the compiler to deal with smaller code segments. A large application usually means a large computational graph. By dividing the large computational graph to smaller segments, the compiler throughput is improved. Many applications, such as NLP, GPT, repeatedly perform certain functions when operating on different data. Thus, a hypersection is created based on code that is repeatedly executed.

The systems and techniques described herein have a software designer annotate an application to identify which parts of the code are being re-used to enable the compiler to create a hyper-section for each portion of code that is repeatedly executed. The compiler uses annotations provided by the code developer to create hyper-sections.

How a computational graph is divided into hyper-sections has performance implications. In some cases, the compiler may not separate 2 portions of code (e.g., 1312(1), 1312(2)) that could be used to create 2 hypersections because a large amount of data is transferred from a first portion (e.g., 1312(1)) to a second portion (e.g., 1312(2)), resulting in a potential performance hit from transferring data to/from temporary storage, such as DDR or DRAM. By placing both portions (e.g., 1312(1), 1312(2)) on-chip (rather than in hypersections), data transfer occurs on-chip, thereby resulting in improved performance due to the faster data transfer. Thus, the compiler reviews I/O between candidate sections (e.g., candidates to be hypersections) because, in cases where there is a lot of I/O between two sections, these execute significantly faster if they are not made into hypersections as they can take advantage of on-board memory to perform faster I/O.

During runtime, if a hypersection is to be executed a subsequent time, the RDU is configured based on a previous configuration used to previously execute similar code. The difference in the subsequent execution of the hypersection is that the address units are configured to obtain inputs from different locations (than the previous execution) and place the output in different locations (than the previous execution). Thus, while a hypersection means that the same code is executed more than once, the subsequent executions may have different inputs/outputs (I/O) at runtime. During runtime, when the runtime driver (e.g., the interpreter) encounters a hypersection, the address units are configured prior to executing the hypersection.

The compiler looks for hypersection annotations in the code of an application and replaces portions of code in an application with the same hypersection. The I/O may be different for each occurrence of a hypersection. In this way, a regular graph (application) is converted into a hypersection based graph.

Map/PnR (place and route) refers to mapping each section (hypersection and regular section) on to hardware and routing data (see for example, FIG. 6). Some operations may be mapped on to the chip (e.g., spatial mapping). In some cases, a portion of the hardware may be mapped (e.g., dedicated to) to specific operations to enable dataflow from operation to operation to occur on the same chip. For example, the output (data) of an operation is saved in on-chip memory and the subsequent operation loads data from the on-chip memory. In this way, most operations happen on-chip to avoid off-chip data transfer. Thus, Map/PnR includes where to map the operations on the chip and how to route the data resulting from the operations.

Thus, by using hypersections, an application is transformed into a hypergraph, e.g., a sequence of hypersections. Some hypersections may implement the same functionality but may take different inputs and produce different outputs. Hypersections map address units at runtime.

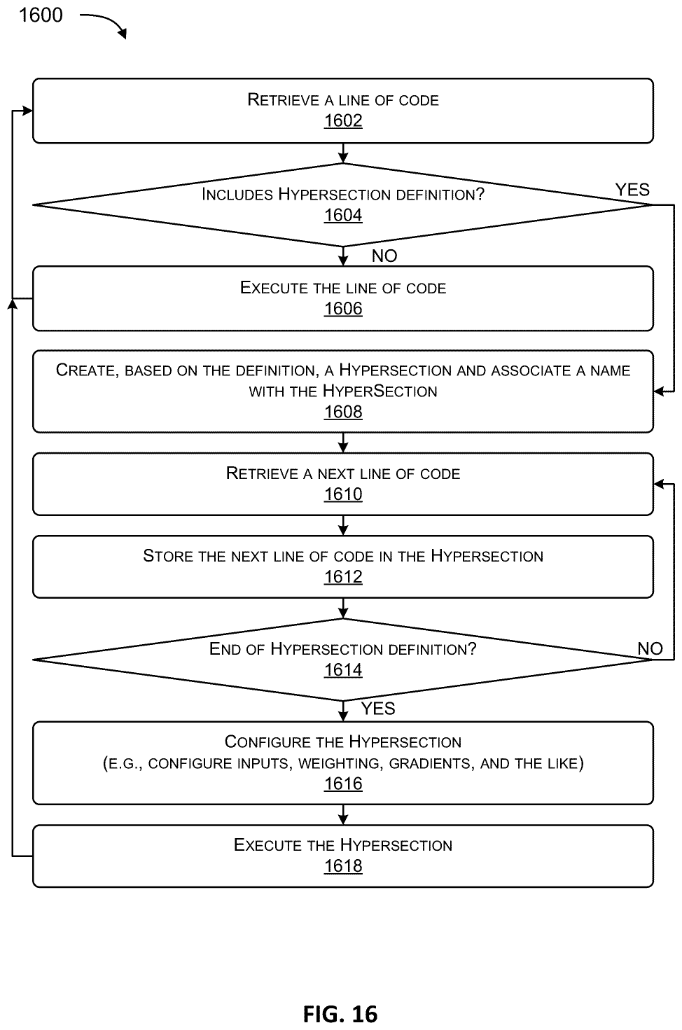

FIG. 16 illustrates a flowchart of a process 1600 that includes creating and executing a hypersection. The process may be performed by the compiler 620, the runtime processes 630 (e.g., interpreter) of FIG. 6, or any combination thereof.

At 1602, the process retrieves a line of code. At 1604, the process determines whether the line of code includes a hypersection definition. If the process determines, at 1604, that “no” the line of code does not include a hypersection definition, then the process executes the line of code, at 1606, and proceed back to 1602 to retrieve a subsequent line of code. If the process determines, at 1604, that “yes” the line of code includes a hypersection definition, then the process, at 1608, creates a hypersection and associates the name with the hypersection, based on the hypersection definition included in the line of code. At 1610, the process retrieves a next line of code and, at 1612, stores the next line of code in the hypersection. At 1614, the process determines whether the hypersection has ended. For example, in FIG. 12, after the process retrieves the first line of code “partial_hyper_sec, func_name=‘linear’)”, the process recognizes that “hyper_sec” in the line of code indicates a hypersection definition. The process continues to retrieve lines of code and store them as part of the hypersection until the process determines that the hypersection definition has ended (e.g., after retrieving the line “return self.lin1(out)”).

If the process determines, at 1614, that “no” the hypersection has not ended, then the process proceeds to 1610, to retrieve a next line of code. If the process determines, at 1614, that “yes” the hypersection has ended, then the process configures the hypersection (using the appropriate weights, inputs, gradients, and the like), at 1616. After configuring the hypersection, the process executes the hypersection, at 1618, and proceeds to 1602 to retrieve a subsequent line of code. Thus, in FIG. 12, the process continues to retrieve lines of code until the process determines that the hypersection definition has ended. After determining that the hypersection definition has ended, the process configures the hyper section with the appropriate weights, inputs, gradients, and the like and executes the hypersection. After executing the hyper section, the process proceeds back to retrieving code subsequent to the code that defined the hypersection.

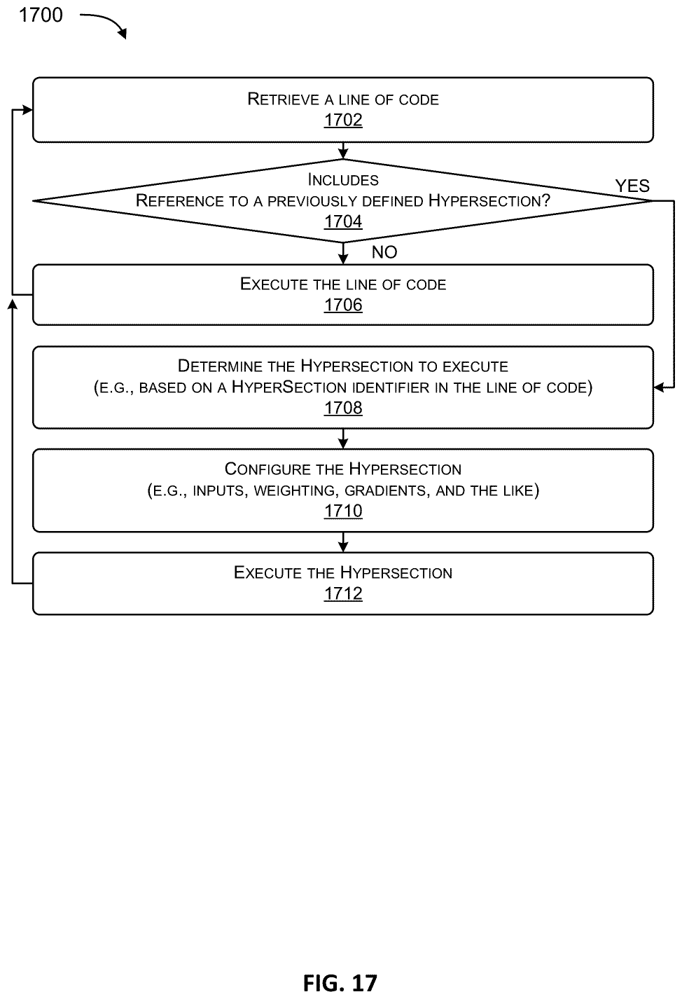

FIG. 17 illustrates a flowchart of a process 1700 that includes executing a previously defined hypersection. The process may be performed by the compiler 620, the runtime processes 630 (e.g., interpreter) of FIG. 6, or any combination thereof.

At 1702, the process retrieves a line of code (e.g., prior to execution). At 1704, the process determines whether the line of code references a previously defined hypersection. If the process determines, at 1704, that “no” the line of code does not reference a previously defined hypersection, then the process executes the line of code, at 1706, and proceeds back to 1702 to retrieve a subsequent line of code. If the process determines, at 1704, that “yes” the line of code references a previously defined hyper section, then, at 1708, the process determines the hypersection that is to be executed (e.g., based on a hypersection identifier in the line of code). At 1710, the process configures the hypersection (e.g., by configuring inputs, weights, gradients and the like) and executes the hypersection, at 1712. For example, in FIG. 14, after the process encounters hypersection 1312(1), the process retrieves the code associated with the hypersection, configures the hypersection 1312(1) (e.g., using the input 1306 and weight 1304(1)), and executes the hypersection 1312(1).

### Particular Implementations

Described implementations of the subject matter can include one or more features, alone or in combination.

For example, in a first implementation, a computer-implemented method to execute a high-level program on a coarse-grained reconfigurable (CGR) processor comprises an array of CGR units. The computer-implemented method comprises: retrieving a line of code included in a high-level program, determining that the line of code includes a hypersection definition, creating a hypersection based on the hypersection definition, associating a name with the hypersection based on the hypersection definition, retrieving one or more subsequent lines of code from the high-level program that are associated with the hypersection, wherein the one or more subsequent lines of code are subsequent to the line of code that includes the hypersection definition, adding the one or more subsequent lines of code to the hypersection, configuring the hypersection, and executing the hypersection.

The foregoing and other described implementations can each, optionally, include one or more of the following features:

A first feature, combinable with any of the previous or following features, wherein: the high-level program comprises an intermediate language that is interpreted in real-time by an interpreter.

A second feature, combinable with any of the previous or following features, wherein determining that the line of code includes the hypersection definition comprises: determining that the line of code includes: an indicator that indicates that a hypersection is being defined, and the name of the hypersection.

A third feature, combinable with any of the previous or following features, further comprising retrieving an additional line of code, determining that the additional line of code references the hypersection, determining the one or more subsequent lines of code included in the hypersection, configuring the hypersection, and executing the hypersection.

A fourth feature, combinable with any of the previous or following features, wherein configuring the hypersection comprises: configuring one or more inputs associated with the hypersection.

A fifth feature, combinable with any of the previous or following features, wherein configuring the hypersection comprises: configuring one or more weights associated with the hypersection.

A sixth feature, combinable with any of the previous or following features, wherein configuring the hypersection comprises: configuring one or more gradients associated with the hypersection.

As another example, in a second implementation, a non-transitory computer-readable storage medium stores computer program instructions that, when executed on a processor, perform operations comprising: retrieving a line of code included in a high-level program, determining that the line of code includes a hypersection definition, creating a hypersection based on the hypersection definition, associating a name with the hypersection based on the hypersection definition, retrieving one or more subsequent lines of code from the high-level program that are associated with the hypersection, wherein the one or more subsequent lines of code are subsequent to the line of code that includes the hypersection definition, adding the one or more subsequent lines of code to the hypersection, configuring the hypersection, and executing the hypersection.

A first feature, combinable with any of the previous or following features, wherein: the high-level program comprises an intermediate language that is interpreted in real-time by an interpreter.

A second feature, combinable with any of the previous or following features, further comprising: retrieving a particular line of code included in the high-level program, determining that the particular line of code does not include the hypersection definition, and executing the particular line of code.

A third feature, combinable with any of the previous or following features, comprising: retrieving an additional line of code, determining that the additional line of code references the hypersection, determining the one or more subsequent lines of code included in the hypersection, configuring the hypersection, and executing the hypersection.

A fourth feature, combinable with any of the previous or following features, wherein configuring the hypersection comprises: configuring one or more inputs associated with the hypersection.

A fifth feature, combinable with any of the previous or following features, wherein configuring the hypersection comprises: configuring one or more weights associated with the hypersection.

A sixth feature, combinable with any of the previous or following features, wherein configuring the hypersection comprises: configuring one or more gradients associated with the hypersection.

As a further example, in a third implementation, a system comprises one or more processors coupled to a memory device. The memory device is used to store computer program instructions that are executable by the one or more processors to perform operations comprising: retrieving a line of code included in a high-level program, determining that the line of code includes a hypersection definition, creating a hypersection based on the hypersection definition, associating a name with the hypersection based on the hypersection definition, retrieving one or more subsequent lines of code from the high-level program that are associated with the hypersection, wherein the one or more subsequent lines of code are subsequent to the line of code that includes the hypersection definition, adding the one or more subsequent lines of code to the hypersection, configuring the hypersection, and executing the hypersection.

A first feature, combinable with any of the previous or following features, wherein: the high-level program comprises an intermediate language that is interpreted in real-time by an interpreter.

A second feature, combinable with any of the previous or following features, wherein: the high-level program implements one or more artificial intelligence algorithms.

A third feature, combinable with any of the previous or following features, wherein the one or more artificial intelligence algorithms comprise: a natural language processing algorithm (NLP), a generative pre-trained transformer (GPT), or any combination thereof.

A fourth feature, combinable with any of the previous or following features, further comprising: retrieving an additional line of code, determining that the additional line of code references the hypersection, determining the one or more subsequent lines of code included in the hypersection, configuring the hypersection, and executing the hypersection.

A fifth feature, combinable with any of the previous or following features, wherein configuring the hypersection comprises: configuring one or more inputs associated with the hypersection, configuring one or more weights associated with the hypersection, configuring one or more gradients associated with the hypersection, or any combination thereof.

### Clauses

1. A system for estimating resource costs for computing tasks for a reconfigurable dataflow computing system includes:
a training module configured to obtain resource costs for a computing template for each configuration of a set of template configurations, the computing template corresponding to a computing task;
the training module configured to train a neural network using the one or more resource costs as training targets to produce a trained neural network; and
an estimation module configured to use the trained neural network to estimate the resources costs for an uncompiled configuration for the computing template and thereby produce estimated resource costs for the uncompiled configuration for the computing template.
2. The system of clause 1, wherein:
the training module is configured to initiate compilation of the computing template for each configuration of the set of template configurations and thereby obtain the resource costs for each configuration of the set of template configurations.
3. The system of clause 1, wherein each configuration comprises a set of configuration parameters.
4. The system of clause 3, wherein the set of configurations parameters comprises one or more of an input size, a filter size, a stride, and a base grid size.
5. The system of clause 1, wherein the resources costs comprise a memory unit count, a compute unit count, and a compute latency.
6. The system of clause 1, further configured to comprise:
an optimization module configured to determine the estimated resource costs for a plurality of proposed configurations and select a selected configuration for the computing template.
7. The system of clause 6, wherein the plurality of proposed configurations comprise a plurality of base grid sizes.
8. The system of clause 6, wherein the selected configuration is selected according to one or more optimization criteria.
9. The system of clause 1, further configured to comprise:
an allocation module configured to allocate resources according to the estimated resource costs for the selected configuration for the computing template to produce allocated resources.
10. The system of clause 9, further configured to comprise:
a configuration module configured to generate dataflow configuration information that enables the reconfigurable dataflow computing system to conduct the computing template according to the allocated resources.
11. The system of clause 9, further configured to comprise:
a runtime module configured to configure the reconfigurable dataflow computing system using the dataflow configuration information.
12. The system of clause 11, wherein:
the runtime module configured to launch execution of the computing template with the reconfigurable dataflow computing system according to the dataflow configuration information.
13. A computer-implemented method for estimating resource costs for computing tasks for a reconfigurable dataflow computing system includes, including:
obtaining resource costs for a computing template for each configuration of a set of template configurations, the computing template corresponding to a computing task;
training a neural network using the one or more resource costs as training targets to produce a trained neural network; and
using the trained neural network to estimate the resources costs for an uncompiled configuration for the computing template and thereby produce estimated resource costs for the uncompiled configuration for the computing template.
14. The computer-implemented method of clause 13, further including:
initiating compilation of the computing template for each configuration of the set of template configurations to obtain the resource costs for each configuration of the set of template configurations.
15. The computer-implemented method of clause 13, wherein each configuration comprises a set of configuration parameters.
16. The computer-implemented method of clause 15, wherein the set of configurations parameters comprises one or more of an input size, a filter size, a stride, and a base grid size.
17. The computer-implemented method of clause 3, wherein the resources costs comprise a memory unit count, a compute unit count, and a compute latency.
18. The computer-implemented method of clause 13, further including:
determining the estimated resource costs for a plurality of proposed configurations and selecting a selected configuration for the computing template.
19. The computer-implemented method of clause 18, wherein the plurality of proposed configurations comprise a plurality of base grid sizes.
20. The computer-implemented method of clause 18, wherein the selected configuration is selected according to one or more optimization criteria.
21. The computer-implemented method of clause 13, further including:
allocating resources according to the estimated resource costs for the selected configuration for the computing template to produce allocated resources.
22. The computer-implemented method of clause 21, further including:
generating dataflow configuration information that enables the reconfigurable dataflow computing system to conduct the computing template according to the allocated resources.
23. The computer-implemented method of clause 22, further including:
configuring the reconfigurable dataflow computing system using the dataflow configuration information.
24. The computer-implemented method of clause 21, further including:
executing the computing template with the reconfigurable dataflow computing system according to the dataflow configuration information.

### FURTHER OR ADDITIONAL CONSIDERATIONS

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods, and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit of the technology disclosed.

What is claimed is:

1. A system for estimating resource costs for computing tasks for a reconfigurable dataflow computing system includes:
a training module configured to obtain resource costs for a computing template for each configuration of a set of template configurations, the computing template corresponding to a computing task;
the training module configured to train a neural network using the one or more resource costs as training targets to produce a trained neural network; and
an estimation module configured to use the trained neural network to estimate the resources costs for an uncompiled configuration for the computing template and thereby produce estimated resource costs for the uncompiled configuration for the computing template.

2. The system of claim 1, wherein:
the training module is configured to initiate compilation of the computing template for each configuration of the set of template configurations and thereby obtain the resource costs for each configuration of the set of template configurations.

3. The system of claim 1, wherein each configuration comprises a set of configuration parameters.

4. The system of claim 3, wherein the set of configurations parameters comprises one or more of an input size, a filter size, a stride, and a base grid size.

5. The system of claim 1, wherein the resources costs comprise a memory unit count, a compute unit count, and a compute latency.

6. The system of claim 1, further configured to comprise:
an optimization module configured to determine the estimated resource costs for a plurality of proposed configurations and select a selected configuration for the computing template.

7. The system of claim 6, wherein the plurality of proposed configurations comprise a plurality of base grid sizes.

8. The system of claim 6, wherein the selected configuration is selected according to one or more optimization criteria.

9. The system of claim 1, further configured to comprise:
an allocation module configured to allocate resources according to the estimated resource costs for the selected configuration for the computing template to produce allocated resources.

10. The system of claim 9, further configured to comprise:
a configuration module configured to generate dataflow configuration information that enables the reconfigurable dataflow computing system to conduct the computing template according to the allocated resources.

11. The system of claim 9, further configured to comprise:
a runtime module configured to configure the reconfigurable dataflow computing system using the dataflow configuration information.

12. The system of claim 11, wherein:
the runtime module configured to launch execution of the computing template with the reconfigurable dataflow computing system according to the dataflow configuration information.

13. A computer-implemented method for estimating resource costs for computing tasks for a reconfigurable dataflow computing system includes, including:
obtaining resource costs for a computing template for each configuration of a set of template configurations, the computing template corresponding to a computing task;
training a neural network using the one or more resource costs as training targets to produce a trained neural network; and
using the trained neural network to estimate the resources costs for an uncompiled configuration for the computing template and thereby produce estimated resource costs for the uncompiled configuration for the computing template.

14. The computer-implemented method of claim 13, further including:
initiating compilation of the computing template for each configuration of the set of template configurations to obtain the resource costs for each configuration of the set of template configurations.

15. The computer-implemented method of claim 13, wherein each configuration comprises a set of configuration parameters.

16. The computer-implemented method of claim 15, wherein the set of configurations parameters comprises one or more of an input size, a filter size, a stride, and a base grid size.

17. The computer-implemented method of claim 3, wherein the resources costs comprise a memory unit count, a compute unit count, and a compute latency.

18. The computer-implemented method of claim 13, further including:
determining the estimated resource costs for a plurality of proposed configurations and selecting a selected configuration for the computing template.

19. The computer-implemented method of claim 18, wherein the plurality of proposed configurations comprise a plurality of base grid sizes.

20. The computer-implemented method of claim 18, wherein the selected configuration is selected according to one or more optimization criteria.
